(19) United States
(12) Patent Application Publication
(10) Pub. No.: US 2005/0066276 A1
(43) Pub. Date: Mar. 24, 2005

(54) Methods for identifying, viewing, and analyzing syntenic and orthologous genomic regions between two or more species

(76) Inventors: Helen M. Moore, Rockville, MD (US); Vivien R. Bonazzi, North Potomac, MD (US); Leslie L. Foster, Germantown, MD (US); Mark Gorokhov, Germantown, MD (US); Olivier Jojic, Annandale, VA (US); Fu Lu, Gaithersburg, MD (US); Douglas Mason, Germantown, MD (US); Zhen Yuan Wang, Vienna, VA (US); Richard E. Wise, Germantown, MD (US); Xiangqun Holly Zheng, N. Potomac, MD (US); Fei Zhong, Rockville, MD (US)

Correspondence Address: HARNESS, DICKEY & PIERCE, P.L.C., P.O. BOX 828, BLOOMFIELD HILLS, MI, 48303, US

(21) Appl. No.: 10/735,606

(22) Filed: Dec. 12, 2003

Related U.S. Application Data
(60) Provisional application No. 60/433,421, filed on Dec. 13, 2002.
(60) Provisional application No. 60/433,431, filed on Dec. 14, 2002.

(51) Int. Cl. G06F 3/00; G06F 9/00; G06F 17/00

(52) U.S. Cl. 715/700

(57) ABSTRACT

A method and interactive screen system for identifying orthologous genomic regions between two or more species can be provided. The method can involve performing a BLAST search using each of the two or more species against each of the other of the two or more species and identifying the best ortholog matches. The interactive screen system can display one or more of (a) a map viewer which can show genomic sequence information of the two or more species with markers therein, (b) a TA viewer which can show at least one contig and fragments which generated the contig, (c) an evidence viewer which can anotate transcribed regions of the genomic data, (d) a synteny viewer which can show syntenic relationships between the genomic sequence data, (e) a multiple sequence alignment viewer which can show multiple sequence alignments of genomic sequences, and (f) a trace viewer which can show single nucleotides in genomic sequences.

### CROSS-REFERENCE TO RELATED APPLICATIONS

This application claims the benefit of U.S. Provisional Application No. 60/433,421, filed on Dec. 13, 2002. This application also claims the benefit of U.S. Provisional Application No. 60/433,431, filed on Dec. 14, 2002. The disclosures of the above applications are incorporated herein by reference in their entirety.

### FIELD

The present disclosure relates to genomic viewers and method for generating data relating to and for viewing syntenic blocks and orthologous genes.

### BACKGROUND

Recent advances in genomic sciences have resulted in entire genomes of several different species becoming available. These genomes can be useful for a variety of research applications, including medical research, forensics, identification, and genealogy.

Orthologous genes are genes occurring in different species that can be derived from a common ancestor. In addition to displaying sequence conservation, orthologs can frequently perform similar functions in different organisms. Several attempts to identify genome-wide pairs of human-mouse orthologs have been made but may be considered mostly incomplete and lacking the systematic supporting evidence necessary to determine with confidence if human-mouse transcript pairs can be true orthologs. Confident identification of orthologs can also rely on the availability of a comprehensive collection of genes from both organisms.

Noncoding genomic sequence that may be shared between different species may also be of great value in biological analysis. Formerly regarded as “junk DNA” by biologists, these noncoding sequence regions can provide valuable information about complex regulatory mechanisms for gene expression.

### SUMMARY

There may be thus provided an interactive display system. The display system may include a database of comparative genomic data from two or more species and a viewer which can integrate the comparative genomic data. The interactive display system may allow the identification of orthologous genes of the two or more species. In one aspect, the comparative genomic data may include syntenic anchors and syntenic blocks from the two or more species. Identification of orthologous genes may therefore be facilitated, and a tool useful in tracing genetic heritage can be provided.

The interactive display system may include one or more components which may be selected from the group consisting of (a) a map viewer which can show s genomic sequence information of the two or more species with markers therein, (b) a TA viewer which can show at least one contig and fragments used to generate the contig, (c) an evidence viewer which can provide annotation information associated with transcribed regions of the genomic data from the two or more species, (d) a synteny viewer which can show syntenic relationships between the genomic sequence data of the two or more species, (e) a multiple sequence alignment viewer which can show multiple sequence alignments of genomic sequences of the two or more species, (f) a trace viewer which can show single nucleotides in genomic sequences of the two or more species, and (g) combinations thereof.

In one aspect a user can interactively select one or more of the viewer components. The interactive display system can be in a stand-alone version or in a web-based version. The database of the interactive display system can comprise complete genomic sequence of the two or more species.

In another aspect of the methods disclosed herein, there may be provided a method for generating a database of genomic sequences of two or more species which can identify orthologous genomic regions between the two or more species. The method may include performing at least one BLAST search using the genomic sequences of each of the two or more species against the genomic sequences of each of the other of the two or more species, selecting the best putative ortholog matches, and identifying the best ortholog matches among the putative ortholog matches.

A method for identifying orthologous genomic regions between two or more species may also be provided. The method may include performing at least one BLAST search using each of the two or more species against each of the other of the two or more species, selecting the best putative ortholog matches, and identifying the best ortholog matches among the putative ortholog matches.

In certain aspects, the methods disclosed herein can further identify syntenic anchors and syntenic blocks which may facilitate selecting the best putative ortholog matches.

The two or more species can be, for example, mouse and human and in certain instances, at least one additional species may be included such as, for example, rat.

In some configurations of the methods, the evidence viewer may have access to large amounts of data. In addition the synteny viewer can have multiple axes capabilities.

A blast alignment graphic may be provided having complex visualization down to the DNA sequence level.

Furthermore, a viewer framework may be provided that allows a quick and easy implementation of future applications and applets. The viewer framework may be compatible with such applications as the Map Viewer, the TA Viewer, The Evidence Viewer, the Synteny Viewer, Multiple Sequence Alignment Viewer and the Trace Viewer as explained below.

The Map Viewer can be used to show gene information to the sequence level, along with a variety of markers, plus public sequences and expression tags required for mRNA, and DNA, RNA, and/or protein sequence entities that can be aligned to a primary sequence for the viewer.

The TA Viewer can be used to show a contig and the fragments that were used to create it, down to the sequence level.

The Evidence Viewer can be used to present more information about the publicly and privately held data that supports the annotation of associated transcripts.

The Synteny Viewer can be used to show relationships between genomic entities belonging to different species.

The Multiple Sequence Alignment Viewer can be used to show multiple sequences aligned to a gene, transcript, or protein.

The Trace Viewer can be used to show variations in the value of single nucleotides in a DNA sequence.

The viewer framework may be compatible with the new visualization requirements such as evidence, synteny, multiple-sequence alignments, and blast alignment graphic. The viewer framework may be used to build both applications and modern applets.

Further areas of applicability of the disclosed methods will become apparent from the detailed description provided hereinafter. It should be understood that the detailed description and specific examples, while indicating the various embodiments, are intended for purposes of illustration only and are not intended to limit the scope of the disclosure.

### BRIEF DESCRIPTION OF THE DRAWINGS

The disclosure will become more fully understood from the detailed description and the accompanying drawings, wherein:

FIG. 1 is an illustration of the construction of syntenic blocks between the human and mouse genomes in some configurations of the disclosed methods. The left panel illustrates the grouping of syntenic anchors at the chromosomal level; the right panel illustrates the further grouping of syntenic anchors into syntenic blocks by order within a chromosome group. Groups that have 2 or less anchors or span 100,000 bp or less can be excluded in configurations illustrated in FIG. 1.

FIG. 2 is an illustration of a process for identifying human-mouse ortholog pairs with supporting evidence. Subject and query transcript databases can be alternatively the human or mouse transcript databases.

FIG. 3A shows a graphical view of the genomic region around the huntingtin gene on human chromosome 4 and mouse chromosome 5 as displayed from various configurations of map viewer of the present invention. This graphical view allows the user to review the orthologous gene relationships and synteny information associated with a specific genomic region. The human huntingtin gene (hCG20633) may be highlighted in red and may be linked to the mouse ortholog (mCG2547) by a line. Additional orthologous gene pairs between human and mouse may surround the huntingtin orthologs.

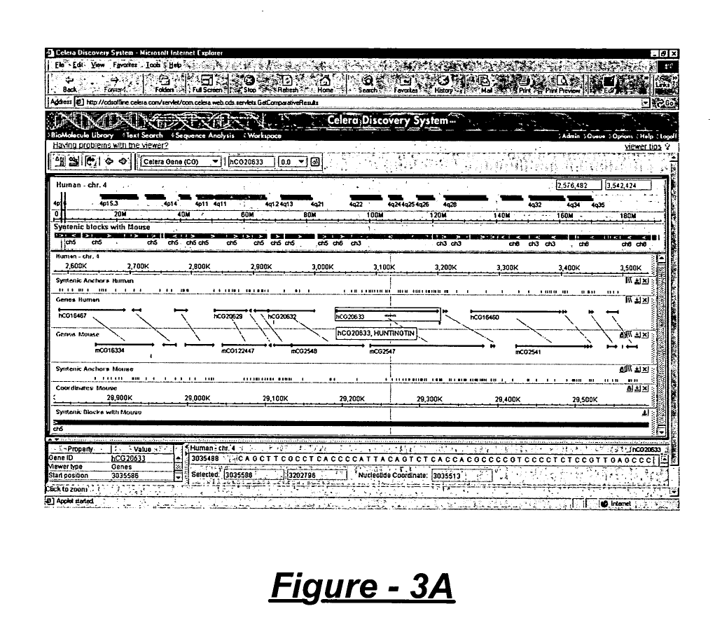

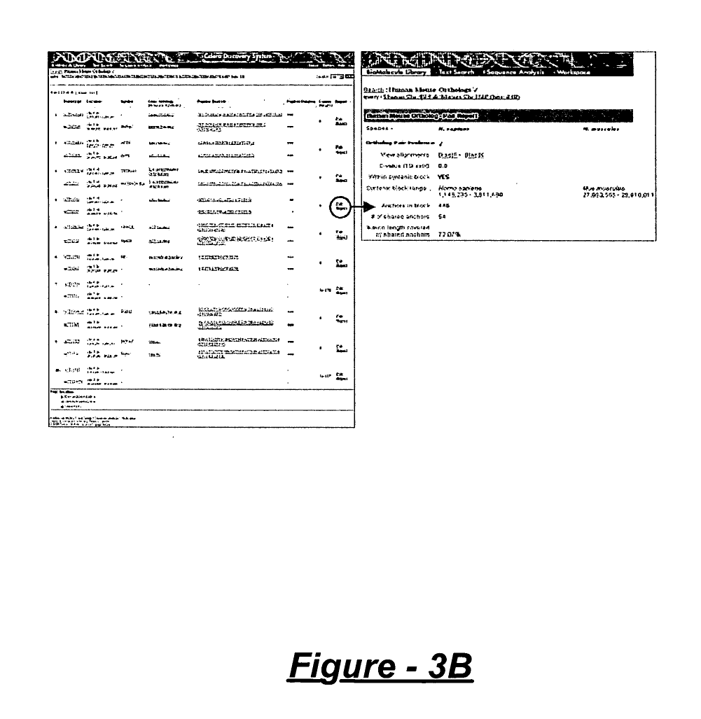

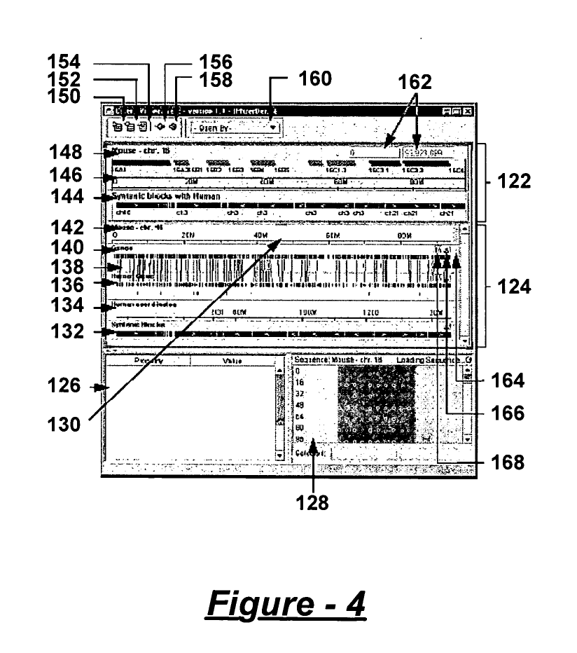

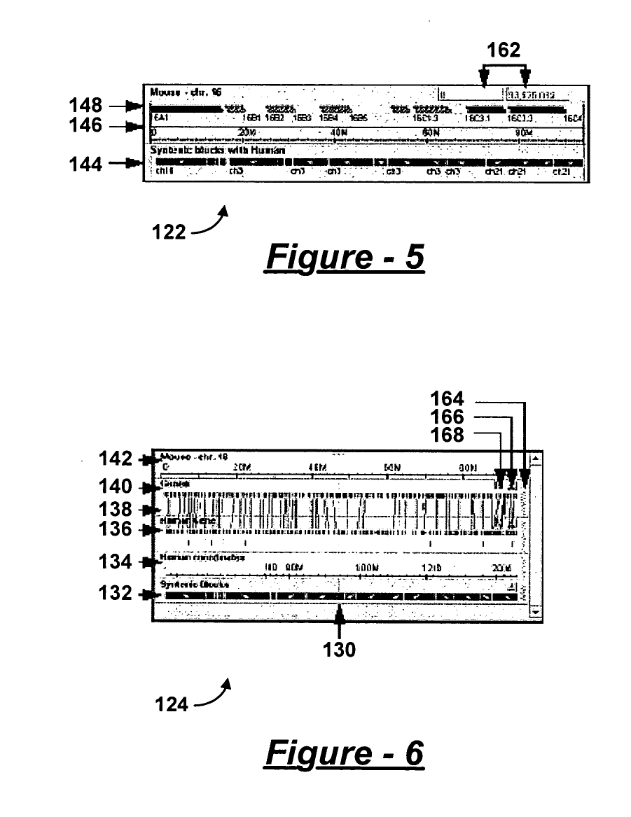

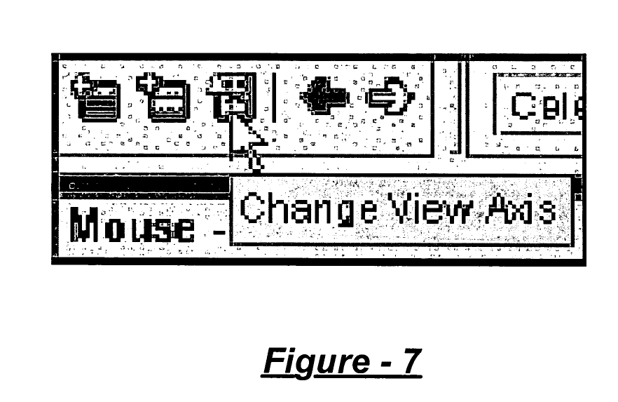

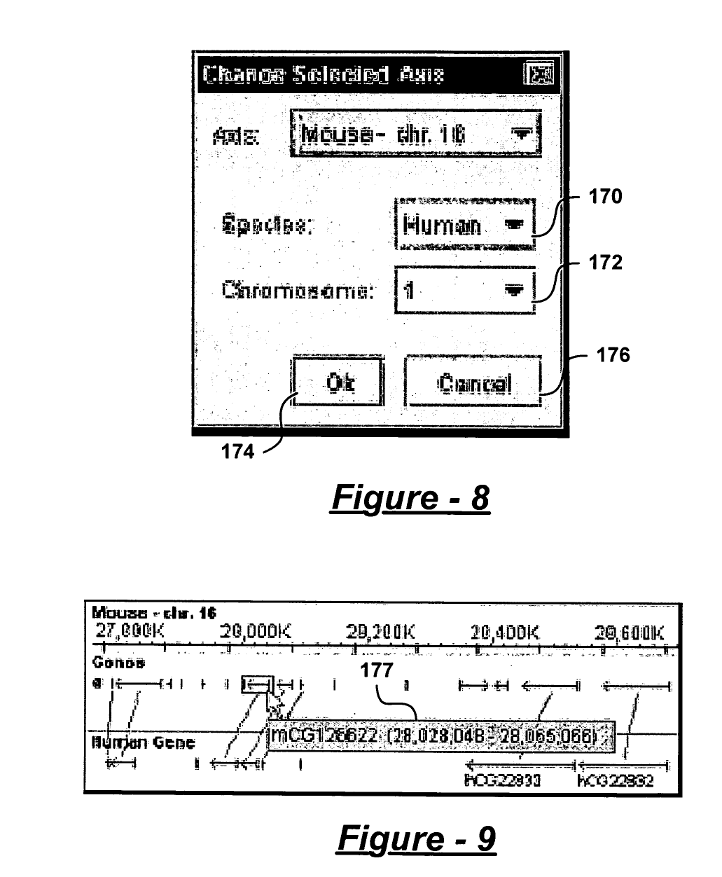

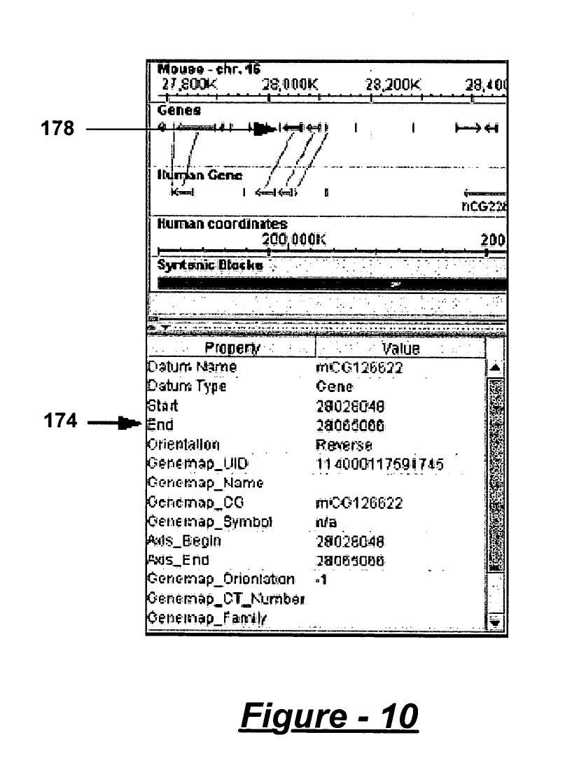

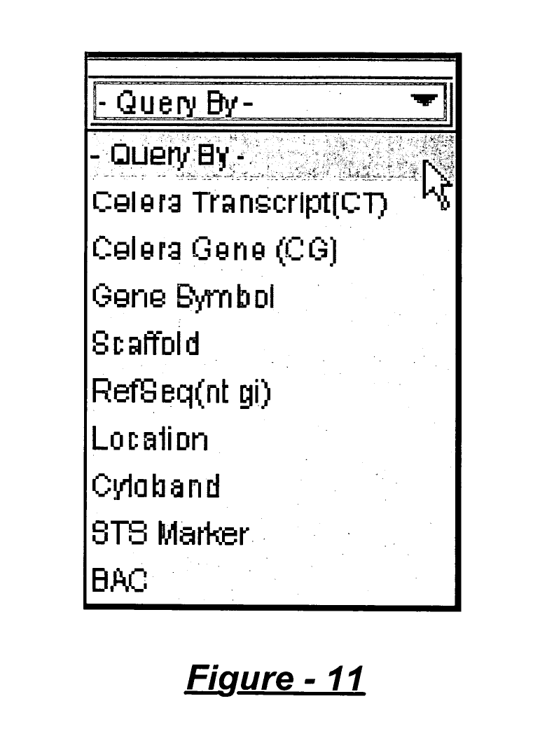

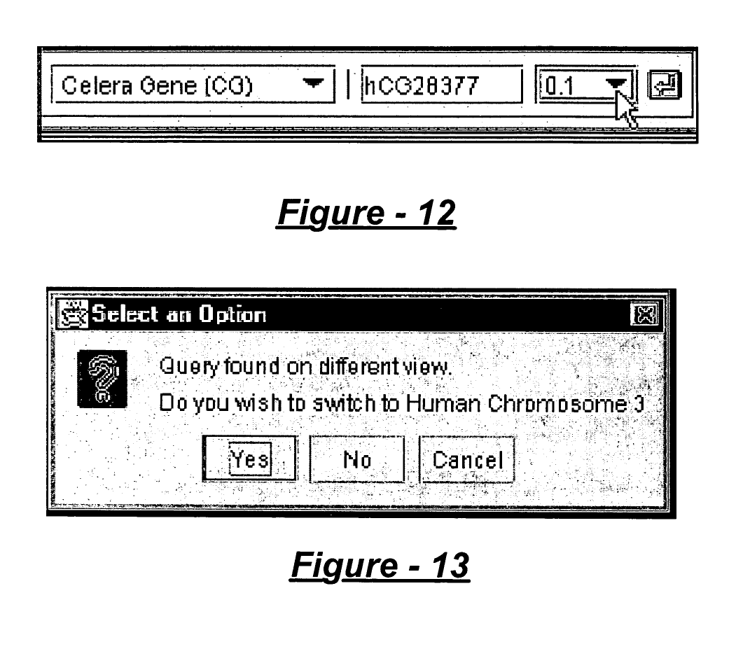

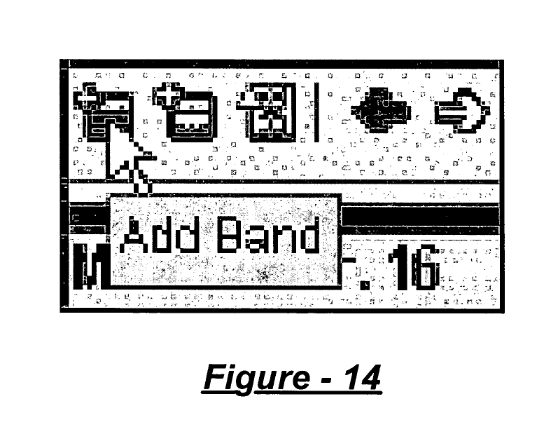

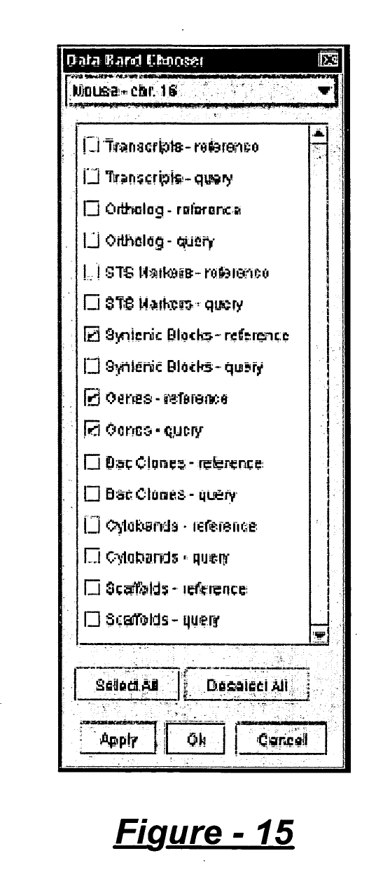

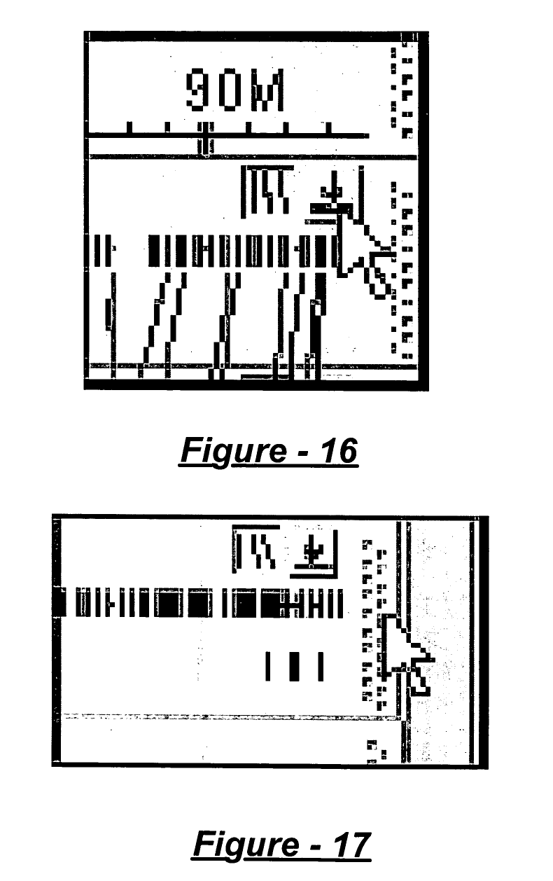

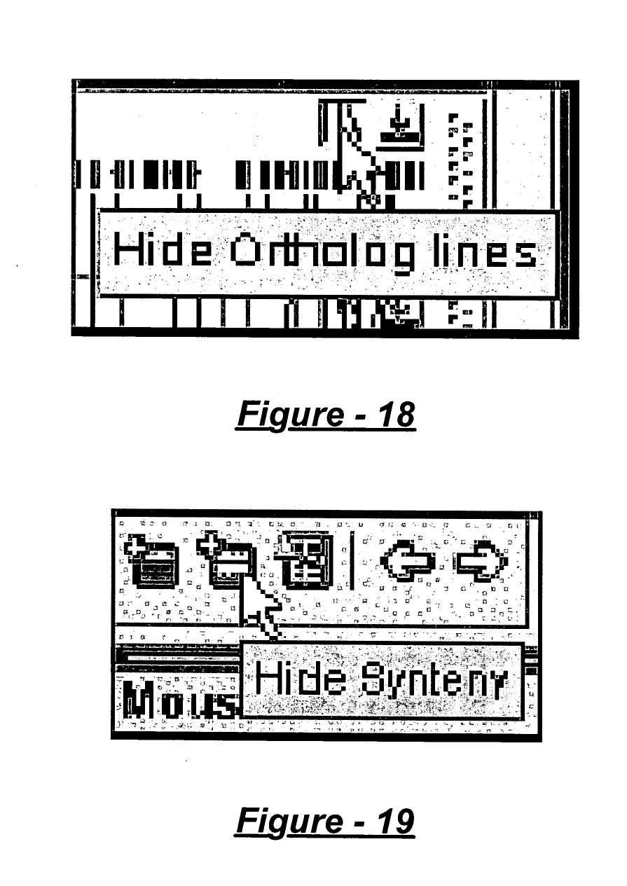

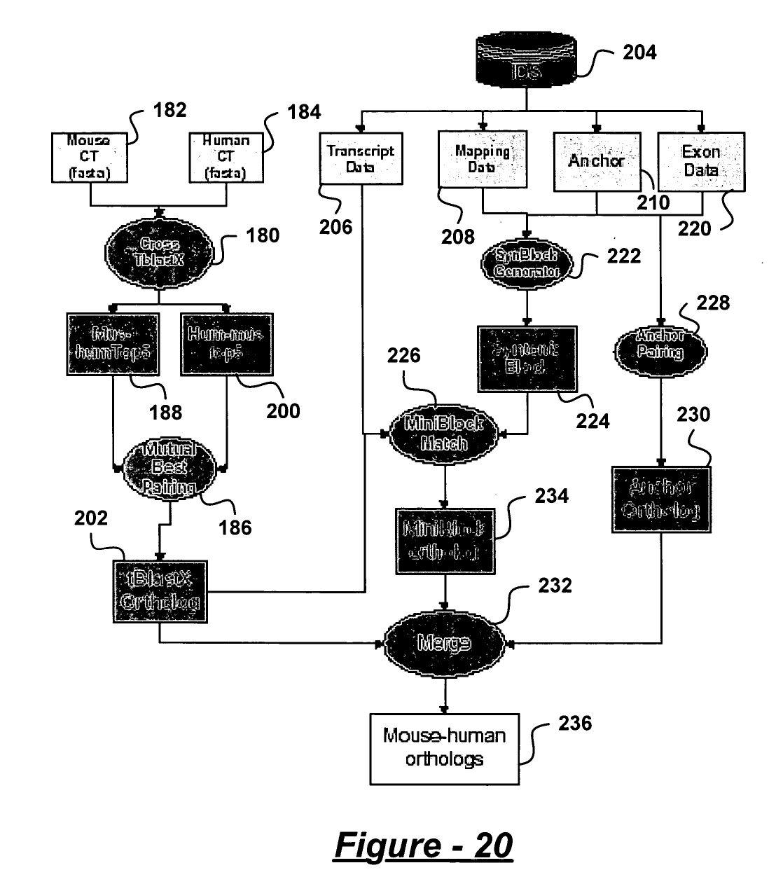

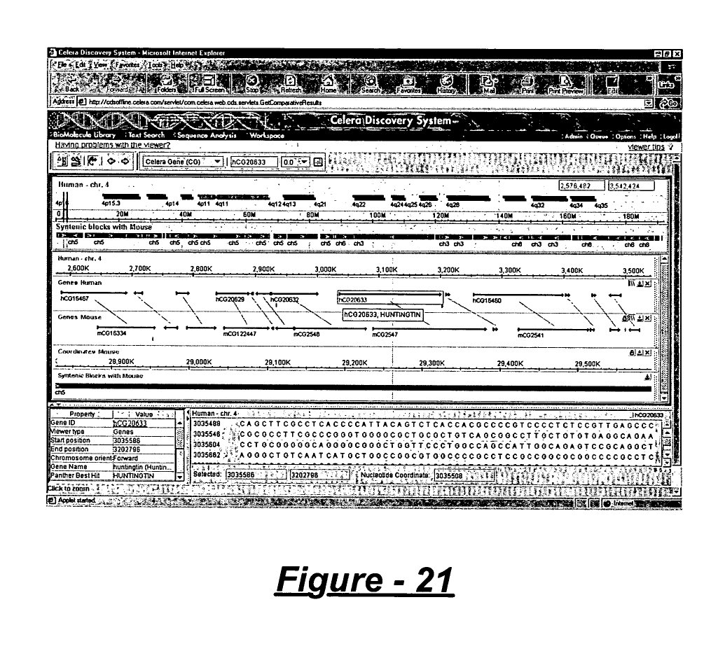

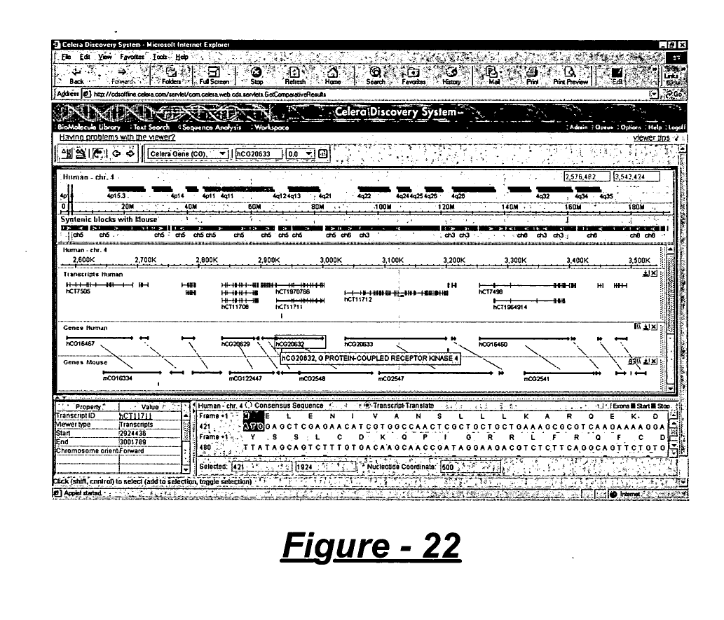

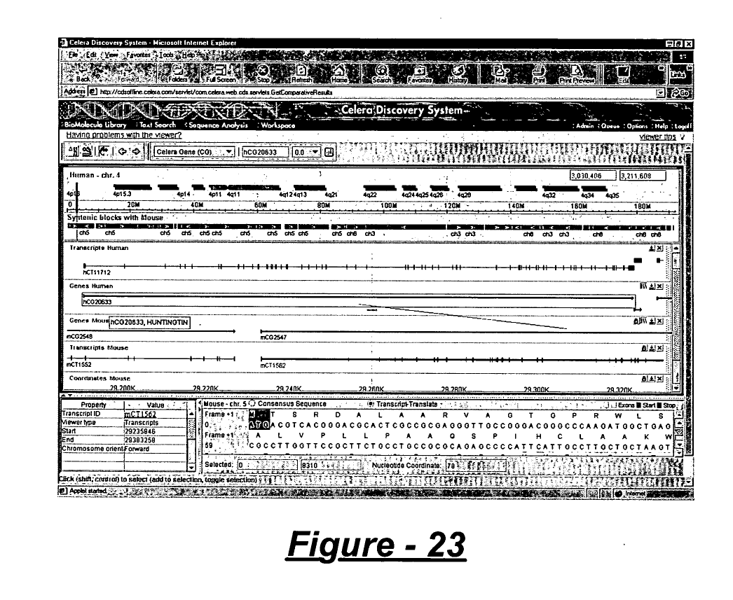

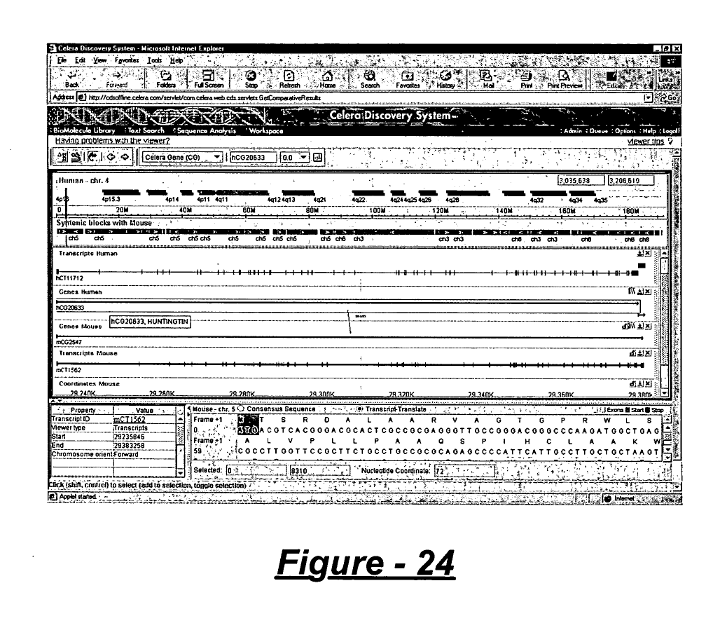

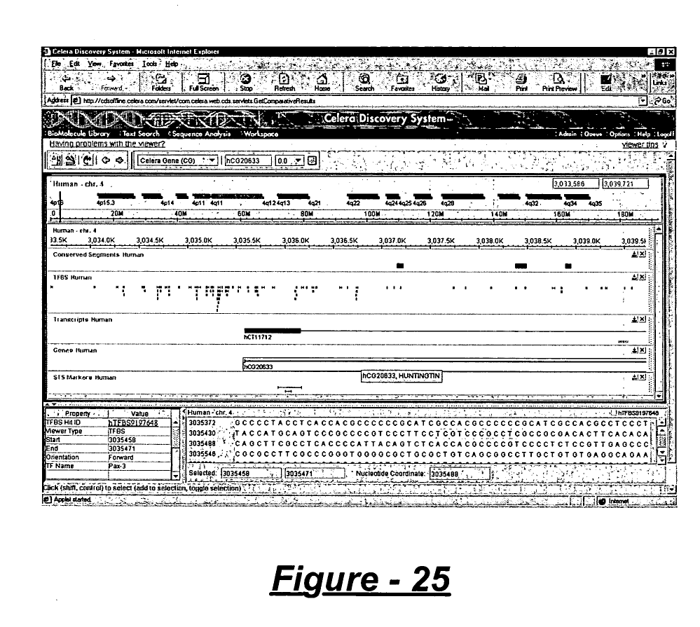

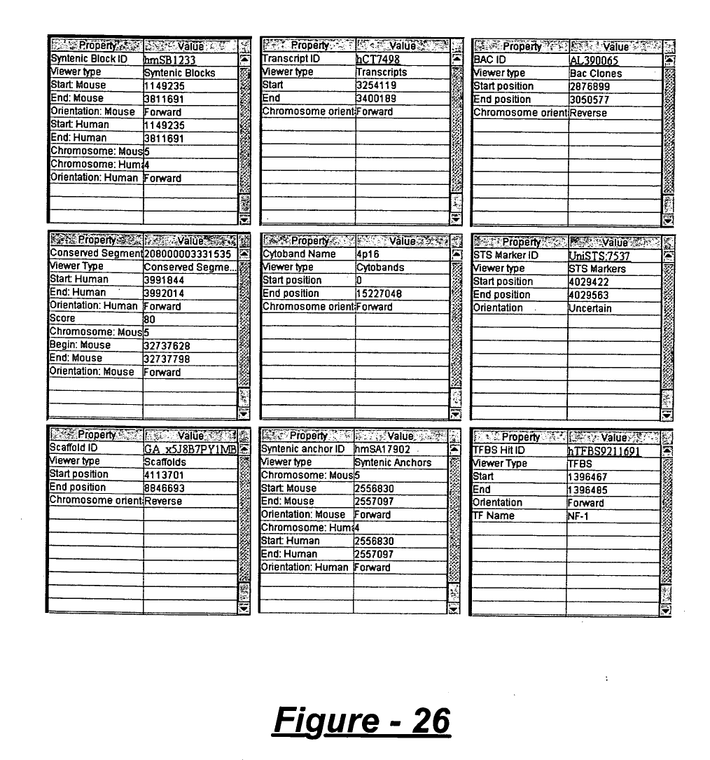

The left panel of FIG. 3B shows a list of human-mouse ortholog pairs identified in the genomic region displayed in FIG. 3A. In some configurations, the list may be generated by selecting the genes in the map viewer and requesting a corresponding gene list by right clicking. The right panel of FIG. 3B displays part of an individual ortholog pair report for the human and mouse huntingtin genes, which may be obtained by clicking on the pair report link in the last column of the left bottom panel. The pair report can provide a summary of the annotation, supporting synteny and functional evidence associated with the huntingtin ortholog pair.

FIGS. 3A and 3B are collectively referred to as “FIG. 3,” in which case, FIG. 3A may be referred to as the “top left panel” of FIG. 3. The left panel and the right panel of FIG. 3B can be referred to as the “bottom left panel” and “bottom right panel” of FIG. 3, respectively. FIG. 3A includes a nucleotide sequence segment of the gene hCG20633 starting at coordinate 3035488 (Seq. ID No. 1).

FIG. 4 is a screenshot representative of various configurations of a synteny viewer.

FIG. 5 is a representation of a typical reference pane of the viewer illustrated in FIG. 4.

FIG. 6 is a representation of a typical feature pane of the viewer illustrated in FIG. 4.

FIG. 7 is a representation of a “change view axis” button click, such as may be provided in some configurations of the present invention to change a viewer's reference genome.

FIG. 8 is a representation of a “change selected axis” dialog box that appears in response to the button click represented in FIG. 7.

FIG. 9 is a representation of a mouse-over of a feature to display its identification number and name.

FIG. 10 is a representation of a property pane for a feature such as that selected in FIG. 9.

FIG. 11 is a representation of a “query by” pull-down list of some configurations of synteny viewers of the present invention.

FIG. 12 is a representation of an ID entered into a text box and the selection of a flanking region from a pull-down list.

FIG. 13 is a representation of a message shown by some configurations of synteny viewers when a query result is on a different axis than that displayed.

FIG. 14 is a representation of an “add band” single click.

FIG. 15 is a representation of a data band chooser dialog box.

FIG. 16 is a representation of a single-click of a “collapse” button of a band appearing in a synteny viewer.

FIG. 17 is a representation of a single-click of a “reorder band” button.

FIG. 18 is a representation of a single-click of a “hide ortholog lines” button.

FIG. 19 is a representation of a single-click of a “hide synteny” button.

FIG. 20 is a representation of various configurations of an orthologs pipeline of the present invention.

FIG. 21 is a screenshot of a viewer without the syntenic anchor tier. However, the viewer represented in FIG. 21 includes expanded property and sequence panes, including nucleotide sequence segments starting at coordinates 3035488 (Seq. ID No. 2), 3035546 (Seq. ID No. 3), 3035604 (Seq. ID No. 4), and 3035662 (Seq. ID No. 5).

FIG. 22 is a screenshot of a viewer that includes the transcript tier, with one transcript of a G-protein coupled receptor kinase highlighted, and a transcript translate view in the sequence pane, including transcript sequence segments starting 421 (Seq. ID No. 7) and 480 (Seq. ID No. 9), and translation segments 421 Frame +1 (Seq. ID No. 6) and 480 Frame +1 (Seq. ID No. 8).

FIG. 23 is a screenshot of a viewer showing a zoomed view of the huntingtin orthologs without the use of the query-specific pan-and-zoom. The sequence pane includes transcript sequence segments 0 (Seq. ID No. 11) and 59 (Seq. ID No. 13), and translation segments 0 Frame +1 (Seq. ID No. 10) and 59 Frame +1 (Seq. ID No. 12).

FIG. 24 is a screenshot of a viewer showing alignment of the huntingtin orthologs with query-specific pan-and-zoom implemented and with the genes in human and mouse aligned with one another. The sequence pane includes transcript sequence segments 0 (Seq. ID No. 15) and 59 (Seq. ID No. 17), and translation segments 0 Frame +1 (Seq. ID No. 14) and 59 Frame +1 (Seq. ID No.16).

FIG. 25 is a screenshot of a viewer showing Celera mappings of transcription factor binding sites (TFBS) in the region of the first exon of the human huntingtin gene. The transcription factor “Pax-3” may be highlighted; its mapping details can be displayed in the properties pane and the sequence may be highlighted in the sequence pane, which includes nucleotide sequence segments starting at coordinates 3035372 (Seq. ID No. 18), 3035430 (Seq. ID No.19), 3035488 (Seq. ID No. 20), and 3035546 (Seq. ID No. 21).

FIG. 26 is a list of properties that can be defined in some configurations of the present invention.

### DETAILED DESCRIPTION

The following description is merely exemplary in nature and is in no way intended to limit the methods, their application, or uses.

As used herein, the term “orthologs” may refer to two genes of different species that share a common evolutionary ancestry. They can be derived from a speciation event and belong to different species.

Also as used herein, the term “ortholog pair” may refer to a set of two transcripts from two different species, wherein the genes containing the transcripts share a common ancestry. Each gene in the pair can have its own chromosomal location on its own genome.

As used herein, the term “synteny” may refer to linkage of genes in different species where gene order in chromosomes may be conserved over wide evolutionary distances. Synteny literally means “same thread.” A “shared synteny” as used herein can refer to two genomic regions in two species that have descended relatively intact from the common ancestor.

As used herein, the term “syntenic anchor” may refer to conserved locations in the two genomes that can be identified by significant DNA sequence similarity and constitute a bi-directionally unique match (i.e., two segments can be designated syntenic anchors if their alignment may be the only significant match either segment may be shown to have to the other genome). A syntenic anchor may have different genomic coordinates in each different species in which it may be identified.

As used herein, the term “syntenic blocks” may refer to evolutionary conserved regions between two species where the majority of syntenic anchors can be consistent with each other and can be in mostly consecutive order. A syntenic block may have different genomic coordinates in each different species in which it may be identified.

As used herein, the term “tBlastX” may refer to a comparison of the six-frame translations of a nucleotide query sequence against the six-frame translations of a nucleotide sequence database.

As used herein, the term “reference genome” may refer to a genome for which one chromosomal axis may be displayed and for which a user may have starting information to compare to another genome. As used herein, the term “query genome” may refer to the genome to which a reference genome may be compared.

In various configurations of the disclosed methods, a set of unique syntenic anchors can be developed across two complete genomes, for example, the human and mouse genomes. These syntenic anchors can be assembled into syntenic blocks that represent larger pieces of evolutionarily conserved genomic regions. In some configurations, syntenic anchors (for example, human/mouse syntenic anchors) can be used to support annotation of gene regulatory regions in the human genome. A genome-wide list of human-mouse orthologs with supporting evidence including the syntenic relationships and functional annotation may be commercially available as an XML file within the web-based Celera Discovery System (CDS) from Applied Biosystems, available on-line by subscription at:
http://www.celeradiscoverysystem.com/index.cfm.

For purposes of illustration, and unless otherwise noted, the mouse genome may be utilized as the reference genome and the human genome may be utilized as the comparative genome (or vice-versa) in the examples herein. Both of these genomes can be available and configurations of the disclosed methods may often utilize these two genomes in this manner. Celera human and mouse transcripts were derived from the annotation process of the Celera Human and Mouse Assembled Genomes, as described in Celera User Bulletin 5001-04-07-001, “Expert Annotation for high confidence gene calling in the Celera Mouse and Human Genomes.” It will be recognized, however, that other genomes may be utilized in place of either the mouse genome or the human genome and that either genome of a pair of genomes can be used the reference genome and the other as the comparative genome, depending upon the purpose of the research being pursued.

A method for identification of orthologs, syntenic anchors and syntenic blocks is now discussed. In some configurations, human-mouse syntenic anchors can be constructed by an “all-against-all” alignment of Celera human and mouse genomes. Human-mouse orthologs can be identified by sequence comparison between all Celera human and mouse transcripts. In addition to sequence homology, several lines of evidence related to synteny (syntenic anchors and syntenic blocks) and functional annotation can be attached to each pair of orthologs to allow a user to assess the validity of the pair.

Syntenic anchors can be sequences which can be unique in each of two or more genomic sequences (e.g. sequences which can be unique in each of human and mouse genomes). Identification of syntenic anchors may be performed in two computational steps. The first step may be an “all-against-all” BLASTN search using the two or more genomic sequences. Prior to the search, repetitive and low complexity regions in the human genome sequence can be masked (i.e. nucleotides replaced by an N). Repetitive sequences which can be masked can be simple repeats (di- and tri-nucleotide repeats), Alu restriction site repeats, long interspersed nuclear elements (LINEs), and short interspersed nuclear elements (SINEs).

The “all-against-all” search may be performed using portions of each of the two genomes such as, for example, scaffolds. Scaffolds can be defined herein to mean about 500,000 contiguous basepairs in a genome. Thus, for example, a BLASTN search using the first scaffold, i.e. the first about 500,000 basepairs of a mouse genome can be performed against one or more scaffolds of the human genome or against the entire human genome. This may be repeated for additional scaffolds of the mouse genome. The reverse BLASTN search, i.e. human against mouse may also be performed.

The degree of similarity of matches may be performed by the BLASTN search tool using statistical sequence comparison and wherein the expected number of high scoring sequence pairs may be identified by an E value threshold set at a low value such as 10⁻⁴. Standard BLASTN filtering removes low complexity regions.

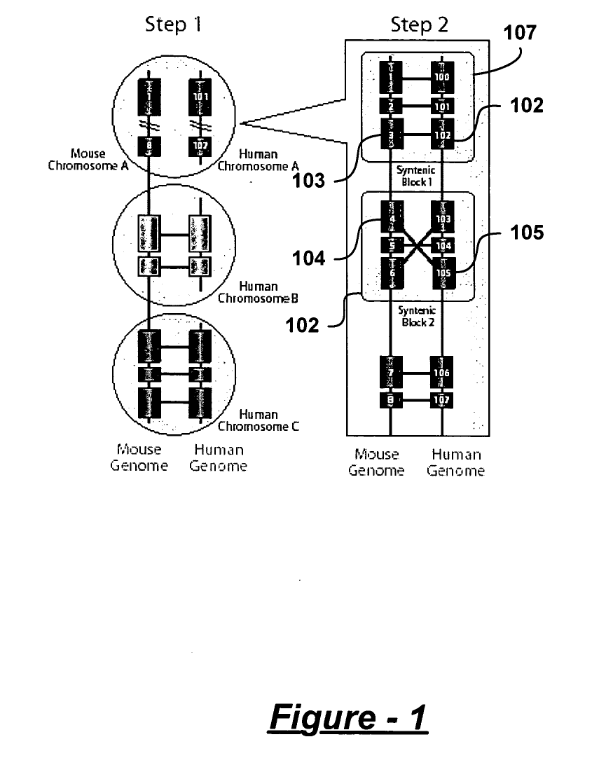

A match between two segments of at least 50 bp and sharing ≧80% identity may be retained and the two segments can be considered syntenic anchors if the two segments can be uniquely matched to one another. Syntenic blocks may refer to evolutionarily conserved regions between the two species where syntenic anchors can be mostly in consecutive order. In various configurations and referring to FIG. 1, syntenic blocks can be generated. First, syntenic anchors can be sorted by their chromosome position on the reference genome (e.g., the mouse genome). These anchors can be then grouped by their chromosome assignments on the comparative genome (e.g., the human genome). Groups having not more than two anchors can be excluded. Next, individual anchor groups can be further divided into finer groups. These groups can be deemed to be syntenic blocks if the anchors on the comparative (e.g., human) chromosome are not in a consecutive ascending or descending order.

In some configurations of the disclosed methods, a block may be considered to end when the order of anchors on the comparative (e.g., human) chromosome jumps two anchor positions or more. For example, in FIG. 1, the set of syntenic anchor pairs 103 and 102 can be followed by the set of syntenic anchors pairs 104 and 105. Therefore these two anchor sets can belong to two different syntenic blocks 107 and 109. Groups that have no more than two anchors or that span 100,000 bp or less on either genome can be excluded.

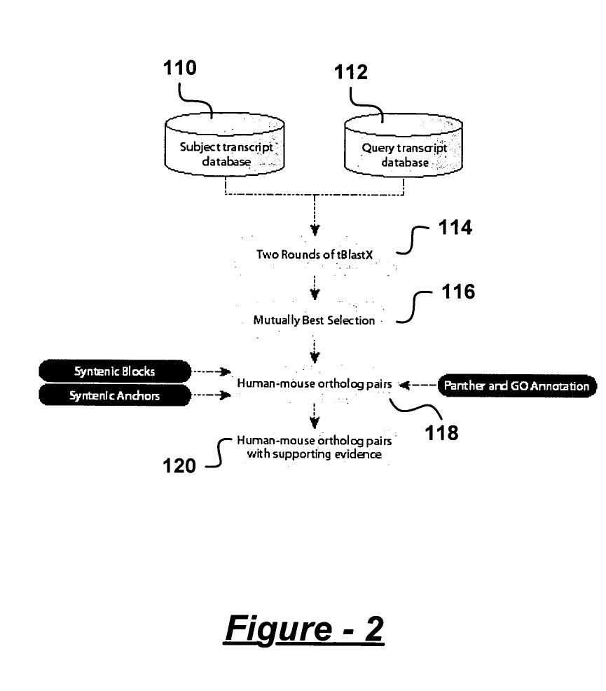

Identification of orthologs may also be performed. In various configurations of the disclosed methods and referring to FIG. 2, human-mouse orthologs can be identified at step 114 utilizing two runs of tBlastX between the Celera human and mouse transcripts (for Blast definitions, see, for example, http://www.ncbi.nlm.nih.gov/BLAST). An E value cut-off of <10⁻⁴ may be used, with subject 110 and query 112 databases swapped between runs. Next, mutually best transcript pairs can be selected at step 116 as putative orthologs between the two species. Mutually best hits can be the top hits in both runs of tBlastX. The same approach can be used to identify orthologs in more than two species.

Using configurations of methods described above, approximately 40% and 35% of human and mouse transcripts, respectively, may have an ortholog in the other species. In some configurations, to provide the most accurate inventory of orthologs, the only qualified transcripts to be putative orthologs can be mutually best matches. Orthologous relationships involving genes that can be duplicated on either genome can be filtered out by this process. Once putative orthologs can be identified, several lines of evidence can be attached to each orthologous pair at step 118 as shown in Table 1 to obtain ortholog pairs with supporting evidence at step 120.

TABLE 1
Description of evidence associated
with human-mouse ortholog pairs

| Evidence Type | Description |
|---|---|
| E VALUE | E value of the tBlastX run between the |
| | transcripts |
| SA NUMBER | Number of syntenic anchors shared by |
| | the exons of the two transcripts |
| SA COVERAGE | Percentage of exon length covered by |
| | the shared anchors |
| BLOCK | Shows whether the two orthologous |
| | transcripts belong to the same syntenic |
| | block |
| PANTHER and GO | Shows the classification of the two |
| | transcripts in PANTHER ™ families and |
| | GO classification |

A pair of transcripts may be likely to be truly orthologous when the transcripts have significant tBlastX E values and can be in the same syntenic block. Thus, in some configurations, two orthologous transcripts can be considered to be inside the same syntenic block if both transcripts can be either contained or overlapped by at least 1 bp within the same block. Ninety-one percent of the orthologous transcripts may belong to the same syntenic Block. The inference that the remaining nine percent of the orthologous pairs do not belong to the same block may be partially explained by the elimination of short syntenic blocks that have not more than 2 anchors or span not more than 100,000 bp.

In some configurations, common Syntenic Anchors shared by the two transcripts can serve as other evidence that supports a putative orthologous pair. For each pair of potentially orthologous transcripts identified by tBlastX, two values can be calculated to represent the degree of anchor sharing at the genomic level (see Table 1). The first value may be the number of anchors shared by the exons of the two transcripts. The second value may be the percentage of total exon length covered by the shared anchors. About 85% of the human-mouse orthologs can share syntenic anchors. The absence of shared anchors for 15% of the orthologs may be partially due to an under-representation of anchors in duplicated regions of the genome, as some configurations can require that anchors be mutually unique, and to the fact that only shared anchors located in exons can be taken into consideration in some configurations.

In addition to sequence conservation, orthologs frequently perform similar functions in different organisms. PANTHER™ protein classification with family or subfamily assignments (1) and GO assignments (2) of the transcripts can be provided as additional evidence to support an orthologous pairing in some configurations. It has been found that 96% of human-mouse orthologs that have a PANTHER™ family assignment fall into the same family. Similarly, 92% of orthologs with GO assignments show the same GO category.

An example of ortholog pairs on human chromosome 4 and mouse chromosome 5 around the huntingtin gene is now discussed. Huntington's disease (HD) is a neurodegenerative disorder that may be associated with mutations in the huntingtin gene located on human chromosome 4p16. In various configurations of the disclosed methods, the mouse ortholog (mCT1562) for the human huntingtin gene (gCT11712) may be found either by text search or by using a configuration of a map viewer, as shown in FIG. 3. The map viewer can allow scientists to examine the human genome and annotation side by side with the genomic features of syntenic regions of the mouse genome.

For example, the genomic context of mCT1562 and hCT11712 may have been examined in a syntenic map view. The view clearly shows that not only may gene pair be orthologous, but the pair may reside in a syntenic region with many surrounding orthologous gene pairs. In addition, both genes can be contained within the same syntenic block. This can provide further confidence about the orthologous relationship between the human and mouse huntingtin genes.

From the map viewer or via text search of the orthologs database, in various configurations, the user can also generate a list of the gene pairs that surround the huntingtin pair in the same chromosomal region. FIG. 3 shows a sampling of human mouse ortholog pairs flanking the huntingtin gene on human chromosome 4 and mouse chromosome 5. Note that, for each pair in this list that shows a PANTHER™ family assignment, the assignment may be the same or very similar. This similarity can provide functional evidence for the orthologous relationships between the genes in these syntenic regions. From the orthologs pairs list, the user can link to the ortholog pair report for the huntingtin gene pair, which can show that the proteins predicted for these two genes share the same PANTHER™ family assignment, and that the two genes reside in the same syntenic block and share syntenic anchors in exon regions.

As shown in the example syntenic views in the map viewer, the ortholog pair list and ortholog pair report can allow rapid and confident identification of human-mouse orthologs with supporting synteny and functional evidence.

The versatility and usefulness of configurations of the synteny viewer are further illustrated in FIGS. 21, 22, 23, 24, and 25. For example, and referring to FIG. 21, a screenshot of a viewer configured without the syntenic anchor tier is illustrated. However, the viewer represented in FIG. 21 may be configured with expanded property and sequence panes.

Referring to FIG. 22, a screenshot of a viewer configured to include the transcript tier, with one transcript of a G-protein coupled receptor kinase highlighted, and a transcript translate view in the sequence pane is shown.

Referring to FIG. 23, a screenshot of a viewer configured to show a zoomed view of the huntingtin orthologs without the use of the query-specific pan-and-zoom is shown.

Referring to FIG. 24, a screenshot of a viewer configured to show alignment of the huntingtin orthologs with query-specific pan-and-zoom implemented and with the genes in human and mouse aligned with one another is shown.

Referring to FIG. 25, a screenshot of a viewer configured to show Celera mappings of transcription factor binding sites (TFBS) in the region of the first exon of the human huntingtin gene is shown. The transcription factor “Pax-3” may be highlighted; its mapping details can be displayed in the properties pane and the sequence may be highlighted in the sequence pane.

Although not shown in the accompanying Figures, in some configurations, the viewer may also be capable of showing SNPs (single nucleotide polymorphisms) in a tier. This functionality facilitates evaluation of gene expression, and can be used in conjunction with analysis of transcription factor binding sites and other measures of gene expression.

A comparison of syntenic anchors, syntenic blocks and human-mouse conserved segments may be now made. In various configurations of the disclosed methods, Syntenic blocks can be derived from syntenic anchors. Syntenic anchors can be markers of evolutionary conservation down to the base pair level. They can be used to infer syntenic relationships between different species to identify syntenic breakpoints, and to provide landmarks for cross-genome navigation and independent confirmation of orthologs. Syntenic blocks can capture the evolutionary conservation from a broader perspective. Sequences within a syntenic block may not be homologous throughout the block, but provide focal points of homology between the two species. Genes within a syntenic block can usually be orthologous and their order on their respective chromosomes can usually be consistent between the two genomes. Scientists can study genes and their orthologous counterparts using the syntenic blocks as a framework.

Human-mouse conserved segments (hmCS) have also been derived from the syntenic anchors, as described in reference Celera User Bulletin 5003-04-07-003, “Annotation of Regulatory Regions in the Celera Human Genome.” The hmCSs also represent evolutionary conservation down to the base pair level. hmCSs can be considered as an extension of the Syntenic Anchors. They can include additional homologous sequences that were filtered out from the syntenic anchors dataset due to their repetitive nature. In some configurations, hmCSs can be used to annotate gene regulatory regions based on a phylogenetic footprinting strategy. hmCSs can also be used as cross-species homology evidence to help gene annotation in either species. In some configurations, the hmCS, gene regulatory regions, syntenic anchors, syntenic blocks, and orthologs can be made available in the map viewer.

In various configurations of the disclosed methods, a synteny investigation system may be provided that enables comparison of the genomic sequence and associated annotation of one species with that of another species. Comparative data, and tools to analyze that data, can be provided. For example, data can be provided for mouse and human genomic sequences with associated annotations. In some configurations, the synteny investigation system comprises a synteny viewer and a comparative genome map query engine. The synteny viewer enables a user to visually compare syntenic block and syntenic anchor regions shared by two or more genomes, and to examine the gene annotation within those syntenic regions. The comparative genome map query enables users to navigate to the synteny viewer and to an existing orthologs product, e.g., the orthologs pairs list, by entering user-supplied genomic interval information (e.g., cytoband range or other chromosome positional information, public BAC, STS marker, etc.).

Some configurations of the disclosed methods provide a jump off point on a subscription-based integrated platform that provides on-line access to a comprehensive and current set of genomic and biological data. For example, some configurations may provide such a jump off point from the Celera Discovery System (CDS) BioMolecule Library (BML) page to bring up a comparative genome map query analysis page (titled “Syntenic Maps”). This jump off point may be provided via a tab link entitled “Comparative Genomics”, in a “Genome Navigation” section, below a “Mouse” tab.

Also, in some configurations of the disclosed methods, when requesting a whole chromosome view from a comparative genome map query, the synteny viewer may be zoomed out completely. When entering other positional information from a comparative genome map query, the synteny viewer may be zoomed to coordinates specified by the query.

In some configurations of the disclosed methods, a user may be able to link from an orthologs pair report page to a synteny viewer, with a zoomed view centered on the gene on that pair report, with the gene occupying 50% of the screen. The pair report in some configurations can display two buttons that symbolize links to the synteny viewer, one for human as reference genome, in the human column, and one for mouse as the reference genome, in the mouse column. In cases in which the user may have navigated from an ortholog grid, the human genome may be used as the reference genome. Some orthologs may not share syntenic blocks. In such cases, it may not be necessary for configurations of the viewer to make visible both members of an ortholog pair. However, in some configurations, the viewer can highlight the visible member of the pair as an ortholog.

Also in some configurations, a user may be able to link from a biomolecule report page (“BMR”) to a synteny viewer, with a zoomed view centered on the gene displayed on that BMR, with the gene occupying 50% of the screen. Links to the synteny viewer can be provided for each BMR page (chromosome, mRNA, protein) in some configurations. The reference genome in the synteny viewer in such configurations may be that genome displayed on the BMR from which the user may be navigating (e.g., if the user may be navigating from a mouse BMR, the reference genome in the synteny viewer may be the mouse genome). In some configurations, a link to the Synteny Viewer from the protein BMR need not be provided.

From a map view generated from another function that shows one species, some configurations of the viewer may permit a user to add a comparative species to generate a syntenic view.

In various configurations, the synteny viewer may be capable of displaying one reference genome axis (i.e., reference chromosome) and one or more query genome axes. For example, when a rat genome may be available, the synteny viewer may be able to display more than two species, for example, human as a reference genome and rat and mouse as query genomes.

Some configurations can allow either of two complete and current genomes, mouse and human, to be available as the reference genome axis or as the query genome. That is, a user may be able to utilize either mouse or human as the reference genome and either mouse or human as the query genome. However, configurations of the methods employing the viewer may not be limited to mouse and human genomes. For example, if rat and Drosophila genomes can be available, either may be made available as the reference genome or the query genome axis.

In some configurations, a synteny viewer may include two separate horizontal panels. One of these panels may be an upper panel that can display an entire chromosome of the reference genome and the syntenic blocks it shares with the query genome. The other panel may be a lower panel that can display a zoomed view of the reference axis and its associated syntenic anchors and genes, along with the genes and syntenic anchors of the genomic region corresponding to the query syntenic blocks. The query genome axis may be displayed as a composite image of the syntenic blocks of the query species that correspond to the reference genome chromosome in the view. Some configurations can permit a user to display additional features of the different genomes using a selection menu available in the viewer.

Various configurations of the methods may place the reference genome axis at the top of the viewer, with cytoband data and coordinate ruler from 0 to maximum displayed in adjacent tiers as displayed in the current CDS mapviewer. The species name of the reference genome may be displayed (e.g., mouse or human).

Syntenic blocks may be displayed in a tier. In various configurations, syntenic blocks can be displayed as a single tier in the upper panel of the viewer. Syntenic blocks that map to the view's reference chromosome can be displayed. The tier may be labeled “syntenic blocks” and additionally labeled with the query species name for the current view (e.g., mouse or human). Because syntenic blocks may not cover the entire genome, in some configurations, there may be gaps between the blocks in the display.

Display of syntenic blocks may include mapping of blocks to the reference chromosome. The reference genome coordinates of each syntenic block can be used in some configurations to map the syntenic block onto the reference chromosome. The blocks can be displayed as lines that cover the region of the genome encompassed by the syntenic block. Block line representation can be labeled underneath with the species name (e.g., “Human” or “Mouse”) of the query genome and the chromosome number for that block in the query genome. The chromosome coordinates of that block on the query genome can be displayed using a “tool tip.” (For example, when a computer mouse cursor hovers over the block for a short while, a small message box may pop up with the chromosome coordinates.)

Display of syntenic blocks may include variable display orientation of blocks. In some configurations of the viewer, arrows can indicate the orientation of the syntenic block in the query genome relative to the block's orientation on the reference genome. Also in some configurations, all syntenic blocks can be assumed to have forward orientation in the reference genome, and the data for the orientation of the block for the query genome may be inferred from the data. For example, all mouse syntenic blocks can be assumed to have forward orientation (+1). Human syntenic blocks can have (+1) or (−1) orientation. If the orientation for both the human block location and the mouse block location is (+1), then the block may be shown as forward (arrow at right). If the orientation for the human block location is (−1) and the mouse block is (+1), the block may be shown as reverse (arrow at left).

More particularly, some configurations of the viewer may load an appropriate chromosome axis for the reference genome. Then, from the syntenic blocks data, syntenic blocks can be found that have location data for that reference genome's chromosome. The chromosome coordinates for those blocks can be pulled for the reference genome, and a line may be drawn for each block. An orientation may be assigned and labeled using an arrow, as described above, and the line may be labeled with the name of the query species and the query chromosome for that block.

One or more zoom bars may be provided. The reference axis and the composite query axis in some configurations of the viewer can be provided with separate zoom bars that initially can be locked together so that the user sees the syntenic regions on a similar visual scale for the reference and query axis. As the user scrolls across the reference axis, the lower panel of the viewer may display features along the reference chromosome. As the user scrolls across the composite query axis, the lower panel of the viewer may display features of each syntenic region, with gaps as revealed by the data. In some configurations, a separate pan and zoom capability may be provided for the query axis, allowing the user to more precisely align features of the different species. For example, the user can visually expand a mouse feature to compare it to a human feature, taking into account the approximately 15% expansion of the human genome relative to the mouse genome. In some configurations, the user may be able to lock and unlock this separate zoom capability.

It may be possible to zoom in on a gene. When a user wishes to zoom in on a gene/transcript in one tier, for example in the tier for the query axis, all tiers of the reference and query genome zoom along with the selected feature in some configurations of the viewer, thereby ensuring that the user does not lose his or her bearings along the reference axis/syntenic region. The separate zoom capability can allow the user to align features of the reference and query genomes that have different magnitudes. For example, a gene in mouse can be orthologous to a gene in human, but due to known differences in genome size, may have different magnitude.

In some configurations, a “history” feature may be provided so that the user can “undo” and get back to where they were. Also in some configurations, a one-step resizing of the zoom bar back to the default size may be provided.

Various configurations of the viewer may provide one zoom bar for the entire syntenic view, including both the reference genome and its features and the query genome and its features. An additional pan and zoom capability may also be available in some configurations for the query genome and its features.

The Synteny viewer may have a lower panel. When accessing a “syntenic view” from an ortholog pair report or from an mRNA tab of a biomolecule report, the following data tiers can be presented in the following order from top to bottom in the viewer in some configurations:
Reference Ruler
Reference Syntenic Anchors
Reference Transcripts
Reference Genes
Query Genes
Query Transcripts
Query Syntenic Anchors
Query Ruler
Syntenic Blocks

When accessing a “syntenic view” from the chromosome tab of a biomolecule report, the following data tiers can be presented in the following order from top to bottom in the viewer in some configurations:
Reference Ruler
Reference Syntenic Anchors
Reference Genes
Query Genes
Query Syntenic Anchors
Query Ruler
Syntenic Blocks

When accessing a “Syntenic View” from within a single species view in the map viewer, the data tiers can be presented as indicated above for the chromosome tab in some configurations of the viewer.

Some configurations allow the user to load optional tiers available in the viewer framework, which may include, as non-limiting examples, transcripts, transcription factor binding sites (TFBS), human-mouse conserved segments (hmCS), scaffolds, STS markers, BACs, single nucleotide polymorphisms (SNPs) in a tier, and so forth. For example, the showing of SNPs in a tier may be useful for evaluation of gene expression, and can be used in conjunction with analysis of transcription factor binding sites and other measures of gene expression. Various configurations of the viewer can display features with appropriate orientation information (arrows). The orientation information may be displayed in a standard format, such as the format utilized in other Celera viewers.

The reference genome may be displayed. In some configurations, the viewer can display the region of the reference genome specified by the zoom bar. The display can include a coordinate ruler that can display the chromosome coordinates of the zoomed region (in order from 0 to maximum), and a cytoband tier.

Reference genome features may be displayed. In various configurations of the viewer, features on the reference chromosome can be loaded into the region specified by the zoom bar.

The query genome may be displayed. Syntenic blocks that can be mapped onto a single chromosome of the reference genome may map to regions on multiple chromosomes in the query genome. In some configurations, the query genome axis may be represented as a composite of all of the syntenic blocks that correspond to the reference chromosome, regardless of the chromosome placement on the query genome. The composite image of the query genome syntenic blocks may be represented as a series of labeled syntenic blocks. Gaps in the tiling of the query syntenic blocks on the reference genome can be represented with tonal shading of the gap. Adjacent blocks with the same query chromosome location can be displayed in the same color, and adjacent blocks with different query chromosome location can be displayed in different colors, thereby indicating breaks in chromosome location and alerting the user that he or she may be observing a discontinuous axis for the query genome.

Display of query genome features may vary. In various configurations, features can be loaded into each syntenic block separately and in other ways. Queries can find all of the genes on the query genome, for example, within the coordinates and overlapping the coordinates of the specified syntenic block. If a gene or transcript overlaps with the syntenic block coordinates, the entire gene or transcript may be displayed.

Forward and reverse orientation may complement the syntenic block. When the orientation of the syntenic block in the query genome relative to the reference genome may be forward, the features within that block can be displayed with forward orientation in various configurations of the viewer. When the orientation of the syntenic block in the query genome relative to the reference genome may be reverse, the features within that block can be displayed with reverse orientation i.e., the reverse complement of that block's features may be displayed.

Features of different syntenic blocks may be distinguished. The break in chromosomal location between the syntenic blocks of the discontinuous query axis can be indicated visually in the tiers for the query genome in some configurations of the viewer. These gaps in the tiling of the query syntenic blocks on the reference genome can be represented with tonal shading of the gap, in each tier displayed for the query genome.

In some configurations, syntenic blocks that can be adjacent to each other on a single query chromosome may be treated as follows. If two or more syntenic blocks can be separated by a gap that may be less than a predetermined distance in kb on the query genome, they may have the same orientation on the query genome, and they can be arranged consecutively on the query genome, the adjacent blocks can be treated as one entity when loading features into the block.

Data entities may interact within the Syntenic viewer. For example, orthologs/homologs may be highlighted. Genes that belong to ortholog pairs can be highlighted in the viewer in some configurations using a line color that may be different from that used for non-orthologs. In some configurations, the user may be able to draw lines between members of the same ortholog pair when both appear in the viewer window. In some configurations, transcripts that belong to ortholog pairs can be highlighted in the viewer using a line color that may be different from that used for non-orthologs, and the user may be able to draw lines between members of the same ortholog pair when both appear in the viewer window.

In various configurations, the user may be able to draw lines between syntenic anchors in the reference and query genomes, and/or draw lines between only two different tiers at one time, e.g., only between human and mouse genes, or only between human and mouse syntenic anchors.

The lines drawn between human and mouse genes can be “on” by default in some configurations of the viewer, and the lines drawn between human and mouse syntenic anchors can be “off” by default, when the user selects a syntenic view. The lines drawn between different tiers can use the coloring scheme from their parent syntenic block, to provide a visual cue to the user of syntenic breakpoints in those tiers.

The Synteny Viewer may contain links to other pages. When clicking on a syntenic anchor in some configurations, the user may be able to link to a page that shows the fasta sequence for that syntenic anchor and may have the ability to launch BlastN. Clicking on a reference genome anchor may link to sequence for anchor in the reference genome; clicking on query genome anchor may link to sequence for query anchor sequence.

In some configurations of the viewer, the user may be able to select a group of genes in the gene tier by dragging, to launch a request for a gene list for those genes, and to launch a request for an ortholog list. Some configurations can provide these options by a menu of options displayed in response to a right mouse click. The user may open these reports in the same Internet browser window or in a new window. These options may include (for configurations utilizing mouse and human genomes):
Mouse gene list (if the selection was performed in a mouse tier)
Human gene list (if the selection was performed in a human tier)
Human-Mouse Orthologs (from either a mouse or human tier) (results page may be the Orthologs Pairs List)

The same functionality may be made available in some configurations when selecting a group of transcripts in a transcript tier.

In some configurations, the user may be able to select a syntenic block and launch the following right click functions:
Mouse gene list
Human gene list
Human-Mouse Orthologs (results page may be the Orthologs Pairs List)

Not all genes have orthologs, so the user may get an error message in some cases (e.g., “No Ortholog has been identified for this gene”) instead of an orthologs pairs list.

The user may open these reports in the same Internet browser window or in a new window.

Various configurations can provide the user with the capability of selecting a gene in the gene tier and of launching various functions using a right click function with the following different options displayed:
Biomolecule Report
Human-Mouse Ortholog (results page may be the Orthologs Pairs List)

Because not all genes have orthologs, the user may get an error message (“No Ortholog has been identified for this gene”) instead of an Orthologs Pairs List.

The user may open these reports in the same Internet browser window or in a new window.

Other functions that can be made available in some configurations may include:
Link to gene regulatory regions (GRR) report
Literature link

Also, some configurations can make the same functionality available when selecting a group of transcripts in a transcript tier.

The user may be able, in some configurations, to select the line connecting two orthologous genes or transcripts, and see a tooltip displaying the Ortholog pair accession for the pair. Some gene pairs can have multiple ortholog pairs. In such cases, the tooltip may display all the ortholog pair accessions that belong to that gene pair.

Some configurations of the viewer can provide the user with the capability of selecting the line connecting two orthologous genes or transcripts, and of launching the following right click function: Link to Ortholog pair report.

As previously noted, not all genes have Orthologs, so the user may get an error message (“No Ortholog has been identified for this gene”) instead of an Orthologs Pairs List.

The user may open these reports in the same Internet browser window or in a new window.

A properties pane for syntenic views may be provided. Some configurations of the viewer can provide the capability for the user to click on a syntenic block and observe the following fields in the viewer properties pane:

| Syntenic Block ID | hmSB# |
|---|---|
| Viewer Type | Syntenic Block |
| Chromosome: Mouse | (chromosome) |
| Start: Mouse | # (begin) |
| End: Mouse | # (end) |
| Orientation: Mouse | forward or reverse (Orientation) |
| Seq length: Mouse | # (SeqLength) |
| Chromosome: Human | (chromosome COMP) |
| Start: Human | # (begin COMP) |
| End: Human | # (end COMP) |
| Orientation: Human | forward or reverse (Orientation COMP) |
| Seq length: Human | # (SeqLength COMP) |
| No. of Syntenic Anchors | # (Anchor number) |

Some configurations can provide the user with the capability of clicking on a syntenic anchor and observing the following fields in the viewer properties pane:

| Syntenic Anchor ID | hmSA# |
|---|---|
| Viewer Type | Syntenic Anchor |
| Chromosome: Mouse | (chromosome) |
| Start: Mouse | # (begin) |
| End: Mouse | # (end) |
| Orientation: Mouse | forward or reverse (Orientation) |
| Seq length: Mouse | # (SeqLength) |
| Chromosome: Human | (chromosome COMP) |
| Start: Human | # (begin COMP) |
| End: Human | # (end COMP) |
| Orientation: Human | forward or reverse (Orientation COMP) |
| Seq length: Human | # (SeqLength COMP) |

A sequence pane may be provided for syntenic views. In some configurations, when the orientation of the syntenic block in the query genome relative to the reference genome may be forward, a feature displayed with forward orientation within that block may be displayed with forward orientation in the sequence pane for the viewer. The reverse complement sequence may be displayed in the sequence pane for a feature displayed with reverse orientation within that block. When the orientation of the syntenic block in the query genome relative to the reference genome may be reverse, a feature displayed with reverse orientation within that block may be displayed with forward orientation in the sequence pane for the viewer. The reverse complement sequence may be displayed in the sequence pane for a feature with forward orientation within that block.

When the orientation of the syntenic block in the query genome relative to the reference genome may be reverse, the features within that block can be displayed with reverse orientation i.e., the reverse complement of that block's features can be displayed. The behavior in the sequence pane may appropriately orient the sequence of those features in the viewer.

The viewer software may be invoked and used in various ways. Various configurations of a synteny viewer may be provided as software stored on a user's computer system, such as a personal computer and display. Although various types of personal computers can be available that run a variety of operating systems, the invocation and use of configurations of the viewer will be described in connection with the Microsoft® Windows® operating system. Any modifications that may be necessary for invocation and use of configurations of synteny viewers for other computer operating systems, such as the OS/X® operating system for Apple® Computer systems and the Linux® operating system, among others, will be readily apparent to those having ordinary skill in the art for coding programs in such operating systems upon reading the description contained herein.

Various configurations of a synteny viewer may be invoked by browsing to locate a directory containing a file invoking the viewer. Once found, the user may double-click on the appropriate file name or icon that invokes the viewer (for example, “synteny.bat”). In some configurations, the synteny viewer may be an applet (e.g., a JAVA® applet) that may be opened in a web browser window, for example, a web browser window viewing a transcript report. The viewer can then provide a display similar to the screenshot in FIG. 4. Various portions of the viewer present in some viewer configurations can include a zoom control 130, syntenic blocks with query genome 132, query genome coordinates 134, and genes on the query genome 136. Various additional portions of the viewer present in some viewer configurations can include ortholog lines 138, genes on the reference genome 140, a reference genome axis 142, syntenic blocks with the query genome 144, and a coordinate ruler with zoom control 146. Various further portions of the viewer present in some viewer configurations can include a reference genome axis 148, and add band button 150, a hide synteny button 152, a change view axis button 154, a backward orientation button 156, a forward orientation button 158, and a query by pull down list menu 160. Various further portions of the viewer present in some viewer configurations can include reference genome coordinates 162, a reorder band button 164, a collapse/expand button 166, and a show/hide ortholog lines button 168. In configurations represented by the screenshot of FIG. 4, these viewer portions may be present when the viewer opens with default settings. Four main viewer panes can be provided in such configurations. These main viewer panes may include a reference pane 122, a feature pane 124, a property pane 126, and a sequence pane 128.

A large volume of data can potentially be displayed. In some configurations in which the viewer may be part of a client program, server-side trimming of data may be utilized to avoid overloading the viewer, client program, and/or client-server network communication link. For example, data that may not be displayed at a current zoom level may not be transmitted over the network communication link.

A representative reference pane 122 is illustrated in FIG. 5. These components can include a reference genome axis 148. The reference genome may be the genome for which the viewer can display starting information to compare to another genome, the query genome. In some configurations, the default reference genome axis may be mouse chromosome sixteen, and the default query genome may be human. In many viewer configurations, the entire reference genome axis may be displayed and cytoband data may be displayed as a band in the reference pane 122 that cannot be moved by a user. However, the feature pane in some configurations can also include the reference genome axis by default, and the user may be permitted to change the band's position within the feature pane. The user may also change the reference axis 148 in many configurations.

Reference genome coordinates 162 can also be included. Reference genome coordinates can be text boxes that show the begin and end coordinates of the reference axis displayed in the feature pane.

A coordinate ruler with zoom control 146 may be further included. This ruler can display the coordinates (for example, in megabases) for the entire reference genome axis. In some configurations, users can utilize a zoom control to pan across or zoom in or out on specific axis regions or features that may appear in the feature pane.

Syntenic blocks with the query genome 144 may yet further be included. A syntenic block may be an evolutionarily conserved region between two or more species where shared syntenic anchors can be in mostly consecutive order on the genome. By definition, a syntenic block may have different genomic coordinates in each different species in which it may be identified. A syntenic anchor may be a region of genomic DNA that may be conserved between two or more genomes. Anchors can constitute bi-directionally unique matches. By definition, a syntenic anchor may have different genomic coordinates in different species. In various configurations such as that represented by FIG. 5, the viewer can display the reference genome's syntenic blocks with the query genome as a band in the reference pane 122 that the user cannot move. However, in some configurations, the feature pane can also display this band, and the user may change the position of the band within the feature pane. Also, if the user changes the viewer's reference axis, this band may change accordingly.

FIG. 6 is a representation of a typical feature pane 124 of the viewer illustrated in FIG. 4. In various viewer configurations, the feature pane 124 may appear in the middle portion of the viewer with the default bands displayed. By default in some configurations, the feature pane can display the following bands: a reference genome axis 142 (in FIG. 6, the reference genome may be mouse chromosome sixteen); genes on the reference genome 140; genes on the query genome 136; query genome coordinates 134 (in FIG. 6, the query genome may be human), and syntenic blocks with the query genome 132. In addition to the default bands, some configurations can also allow the user to display the following information for the reference and/or query genomes: transcripts; orthologs; STS markers; Bac Clones Cytobands; syntenic anchors; transcription factor binding sites (TFBS); human-mouse conserved segments (nmCS) and scaffolds.

A description of default feature pane components in some configurations of the viewer follows. For example, the reference genome axis 142 may be described. The reference genome may be the genome for which the viewer can display starting information to compare to another genome, the query genome. The default reference genome axis in some configurations may be mouse chromosome sixteen, and the default query genome may be human. Some configurations can permit the user to change the reference genome axis band's position within the feature pane, and/or to change the reference axis.

Genes on the reference genome 140 are also described. This band can display the genes associated with the reference genome. In some configurations, the viewer provides detailed information about these genes.

Ortholog lines 138 can be further described. These lines can connect ortholog pairs between genes on the reference and query genome. An ortholog pair may be a set of two transcripts from two different species, where the genes share a common ancestry. Each gene in the pair may have its own chromosomal location on its own genome. The ortholog lines 138 can be shown by default in some configurations, but may be hidden by the user based on input to show/hide orthologs button 168. Connecting lines may also be drawn between syntenic anchors in the different species. The connecting lines for orthologs and syntenic anchor data entities can be visible to the user in some configurations even if one of the endpoints of the entity may be off screen, but can be suppressed when the angle may be too flat (i.e., within a predetermined angle of being horizontal in the illustrated configurations) to thereby decrease clutter.

Genes on the query genome 136 are yet further described. This band can display the genes associated with the query genome. In some configurations, the viewer provides detailed information about these genes.

Query genome coordinates 134 and syntenic blocks with the query genome 136 are still further described. These bands can display the query genome coordinates and the syntenic block regions with the query genome. If the placement of a syntenic block on the query genome may be opposite in orientation to its placement on the reference genome, then the features in the syntenic block can be reverse complemented. Users may change the position of these bands within the Feature pane 124 using reorder band button 164.

Finally, users may employ collapse/expand button 166 to select whether to view the Feature pane 124.

Referring again to FIG. 4, the property pane 126 can display detailed information about a selected entry in the feature panel 24. A sequence pane 128 may also be provided.

Various configurations of synteny viewers may utilize a default reference genome axis, for example, mouse chromosome sixteen, but allow the viewer's reference genome axis to be changed by the user. For example, the following method may be provided to change the synteny viewer's reference axis. First, the user may single-click the “change view axis” button (as shown in FIG. 7). A “change selected axis” dialog box may then appear (as shown in FIG. 8). Then, the user may select a species from the pull-down list of species 170. Next, the user may select a chromosome number from the pull-down list of chromosomes 172. Finally, the user may click the OK command button 174 to save the changes, or click the CANCEL command button 176 to exit the dialog box without saving the changes.

If the changes can be saved, the synteny viewer may display the selection as the new reference axis and change the displayed bands accordingly. A method for displaying the properties of a feature in some configurations of the viewer can include moving the mouse over a feature to display its coordinates in a tool tip 177 (as shown in FIG. 9). Then the user may single-click on the feature 178 in the viewer. In response to the single-click, the property pane 126 can display the information for the selected viewer, as shown in FIG. 10.

Some configurations may provide users with the ability to search for features in a synteny viewer. For example, in some configurations, to search for a feature, the user may perform the following steps. First, the user may select a feature type from the “query by” pull-down list, as shown in FIG. 11. Then, the user may type an ID in the adjacent text box, and select a flanking region from a pull-down list, if desired (as shown in FIG. 12). Next, the user may click the search button. If the query result may be on the same axis as the current reference axis, some viewer configurations may select the result in the view and display its properties in the property pane.

In some configurations, if the query result may be on a different axis, the synteny viewer will display a message such as that shown in FIG. 13. Clicking YES can result in the viewer changing the reference axis and zooming to the search result, displaying its properties in the property pane.

Some configurations of synteny viewers can utilize a case-sensitive search and may require an appropriate ID prefix. For example, to search for a Celera human gene, the “hCG” prefix may be required before the ID in some configurations of the viewer. Likewise, searching for a Celera mouse gene may require the “mCG” prefix.

Various configurations can permit a user to show or hide one or more bands displayed in the synteny viewer. However, some configurations may not permit a user to hide the reference genome axis or the syntenic blocks with query genome axis, both of which may be in the upper panel of some viewer configurations.

To change the displayed bands in some configurations of a synteny viewer, a user may perform the following steps. First, the user may single click the “add band” button as illustrated in FIG. 14. A “data band chooser” dialog box may then appear, as shown in FIG. 15. Then, the user may click in a band's corresponding check box to select or deselect the band. Next, the user may click APPLY to save the changes without exiting the dialog box, or click OK to save the changes and exit the dialog box.

In some configurations, a user may collapse or expand a band that appears in the synteny viewer without removing it from the viewer. However, in some configurations, a user may not collapse the reference genome axis or the syntenic blocks with the query genome axis.

To collapse a band, in some configurations, a user may perform the following steps. First, the user may single-click the band's corresponding “collapse” button (as represented in FIG. 16). Next, the user may expand a band after it may have been collapsed by single-clicking the button again.

In some configurations, a user may move the position of a band that appears in the feature pane, but not bands that appear in the reference pane. To move a band's position in the feature pane, in some configurations, the user may perform the following steps. First, the user may single-click the “reorder band” button, as shown in FIG. 17. Next, the user may drag the band up or down to the desired position in the feature pane.

By default in some configurations of the viewer, the synteny viewer can display connecting lines between orthologous pairs in the reference and query genomes' genes bands. In some configurations, the synteny viewer may provide the user with the ability to hide the ortholog lines. The user may perform the following steps to hide the ortholog lines in some configurations of the viewer. First, the user may single-click the “hide ortholog lines” button (as represented in FIG. 18). Next, the user may display the ortholog lines after they have been hidden by single-clicking the hide ortholog lines button again.

Some configurations of the viewer can open by default with the synteny viewer displayed. However, some configurations may also provide a genome map viewer, and the program can provide the user with the ability to toggle between the synteny viewer and the genome map viewer. In some configurations of the viewer, the user may perform the following steps to change between viewers. First, the user may single-click the “hide synteny” button, as shown in FIG. 19. The genome map viewer may then appear. Then, the user may return to the synteny viewer by single-clicking the button again.

Table 2 below describes ortholog properties in some configurations of the viewer. Some configurations may utilize a subset of the properties listed here. Properties need not be limited to those listed in this table. Some configurations may add additional properties not listed for implementation convenience and/or to expand the set of available features.

TABLE 2
Ortholog properties and descriptions

| Property | Description |
|---|---|
| Datum Name | The Celera Ortholog accession number |
| | and version number, if applicable, |
| | separated by a period. In the following |
| | example, hmCOR12345 may be the |
| | Celera Ortholog accession number, |
| | and 1 may be the version of the record: |
| | hmCOR12345.1 |
| Datum Type | The value may be always “ortholog” |
| Start | The begin position of the ortholog on |
| | the selected chromosome axis. |
| End | The end position of the ortholog on the |
| | selected chromosome axis. |
| Orientation | The orientation of the ortholog on the |
| | selected chromosome axis. One of the |
| | following values appears: forward or |
| | reverse. |
| ID | The Celera Ortholog accession number |
| | and version number, if applicable, |
| | separated by a period. |
| Accession | The Celera Ortholog accession number |
| | and version number, if applicable, |
| | separated by a period. |
| Evalue | The tblastx evalue between the two |
| | transcript sequences. |
| SANumber | The number of syntenic anchors |
| | shared by the two orthologous |
| | transcripts. Syntenic anchors can be |
| | conserved locations in two species that |
| | can be identified by significant DNA |
| | sequence similarity and constitute a bi- |
| | directionally unique match. |
| SACoverage | The percentage of exon length covered |
| | by shared anchors. |
| INBlock | Indicates whether a gene may be in the |
| | same syntenic block as its orthologous |
| | counterpart. One of the following |
| | appears: yes or no. Syntenic blocks |
| | can be evolutionary conserved regions |
| | between two species where the |
| | majority of syntenic anchors can be |
| | consistent with each other and can be |
| | in mostly consecutive order. |
| SAINBlock | The number of anchors in the block. |
| Species | The species of the query dataset that |
| | contained the query genes for the |
| | orthologous pairs. For example, Mus |
| | musculus. |
| CG | The Celera Gene ID to which the |
| | sequence corresponds. |
| CP | The Celera Protein ID to which the |
| | sequence corresponds. |
| CT | The Celera Transcript ID to which the |
| | sequence corresponds. |
| Genename | The gene name. If no value may be |
| | assigned, “unknown” appears. |
| Class | The evidence class for the |
| | corresponding sequence. One of the |
| | following appears: |
| | Otto: Otto may be a conservative, |
| | integrated, evidence-based approach |
| | to identify genes. The evidence used |
| | to increase the likelihood of identifying |
| | genes includes regions conserved |
| | between human and mouse genomes, |
| | similarity to ESTs or other mRNA- |
| | derived data or similarity to other |
| | proteins. Otto demonstrated greater |
| | sensitivity and specificity in the ability |
| | to define gene structure in a |
| | comparison with Genscan, a standard |
| | gene prediction algorithm. |
| | PROMOTEn. Gene predictions with |
| | supporting evidence, where n equals |
| | the number of evidence categories and |
| | may be a value between 1 and 4. in |
| | cases in which Celera computational |
| | annotation/Otto did not identify a gene, |
| | predictions derived from ab initio |
| | programs (Genscan, GrailExp, |
| | FgenesH) with one or more evidence |
| | categories. |
| | expert. The transcript may be the |
| | result of expert curation by annotators. |
| Status | Indicates whether the associated gene |
| | may be classified as a pseudogene. |
| | One of the following appears: |
| | Pseudogene. The associated gene |
| | may be classified as a pseudogene. |
| | Gene. The associated gene may be |
| | not classified as a pseudogene. |
| Chromosome | The chromosome number on which the |
| | associated gene may be located. |
| Orientation | The orientation of the associated gene |
| | on the genome. |
| Begin | The start location of the associated |
| | gene on the genome. |
| End | The end location of the associated |
| | gene on the chromosome |
| Scaffold | The Celera Genomic Assembly (GA) |
| | number on which the associated gene |
| | may be located. |
| Symbol | The gene symbol. If no value may be |
| | assigned, “unknown” appears. |
| Go | The Gene Ontology name. If no value |
| | may be assigned, “unknown” appears. |
| GO_id | The Gene Ontology ID. If no value |
| | may be assigned, “unknown” appears. |
| Panther | The PANTHER ™ Family or Subfamily |
| | name. If no value may be assigned, |
| | “unknown” appears. |
| Panther_Accession | The PANTHER ™ family of subfamily |
| | accession number. If no value may be |
| | assigned, “unknown” appears. |
| Panther_Score | The confidence level of a PANTHER ™ |
| | classification |
| Species_COMP | The species of the subject dataset that |
| | contained the subject genes for the |
| | orthologous pairs. For example, Homo |
| | sapiens. |
| CG_COMP | The Celera gene ID in the subject |
| | dataset to which the sequence |
| | corresponds. |
| CP_COMP | The Celera protein ID in the subject |
| | dataset to which the sequence |
| | corresponds. |
| CT_COMP | The Celera Transcript ID in the subject |
| | dataset to which the sequence |
| | corresponds. |
| Genename_COMP | The gene name in the subject dataset. |
| | If no value may be assigned, |
| | “unknown” appears. |
| Class_COMP | The evidence class for the |
| | corresponding sequence. One of the |
| | following appears: |
| | Otto: Otto may be a conservative, |
| | integrated, evidence-based approach |
| | to identify genes. The evidence used |
| | to increase the likelihood of identifying |
| | genes includes regions conserved |
| | between human and mouse genomes, |
| | similarity to ESTs or other mRNA- |
| | derived data or similarity to other |
| | proteins. Otto demonstrated greater |
| | sensitivity and specificity in the ability |
| | to define gene structure in a |
| | comparison with Genscan, a standard |
| | gene prediction algorithm. |
| | PROMOTEn. Gene predictions with |
| | supporting evidence, where n equals |
| | the number of evidence categories and |
| | may be a value between 1 and 4. in |
| | cases in which Celera computational |
| | annotation/Otto did not identify a gene, |
| | predictions derived from ab initio |
| | programs (Genscan, GrailExp, |
| | FgenesH) with one or more evidence |
| | categories. |
| | expert. The transcript may be the |
| | result of expert curation by annotators. |
| Status_COMP | Indicates whether the associated gene |
| | may be classified as a pseudogene. |
| | One of the following appears: |
| | Pseudogene. The associated gene |
| | may be classified as a pseudogene. |
| | Gene. The associated gene may be |
| | not classified as a pseudogene. |
| Chromosome_COMP | The subject species' chromosome |
| | number on which the associated gene |
| | may be located. |
| Orientation_COMP | The orientation of the associated gene |
| | on the genome in the subject dataset. |
| Begin_COMP | The start location of the associated |
| | gene on the chromosome in the subject |
| | dataset. |
| End_COMP | The end location of the associated |
| | gene on the chromosome in the subject |
| | dataset. |
| Scaffold_COMP | The Celera Genomic Assembly (GA) |
| | Number on which the associated gene |
| | may be located. |
| Symbol_COMP | The gene symbol. If no value may be |
| | assigned, “unknown” appears. |
| Go_COMP | The Gene Ontology name. If no value |
| | may be assigned, “unknown” appears. |
| Go_ID_COMP | The Gene Ontology ID. If no value |
| | may be assigned, “unknown” appears. |
| Panther_COMP | The PANTHER ™ family or subfamily |
| | name. If no value may be assigned, |
| | “unknown” appears. |
| Panther_Accession_COMP | The PANTHER ™ family or subfamily |
| | accession number. If no value may be |
| | assigned, “unknown” appears. |
| Panther_Score_COMP | The confidence level of a PANTHER ™ |
| | classification. |
| Block_Start | The start position of the syntenic block |
| | for the query species. |
| Block_End | The end position of the syntenic block |
| | for the query species. |
| Block_Start_Comp | The start position of the syntenic block |
| | for the subject species. |
| Block_End_Comp | The end position of the syntenic block |
| | for the subject species. |

Table 3 below describes STS Marker properties. Some configurations may utilize a subset of the properties listed here. Properties need not be limited to those listed in this table. Some configurations may add additional properties not listed for implementation convenience and/or to expand the set of available features.

TABLE 3
STS Marker properties and descriptions

| Property | Description |
|---|---|
| Datum Name | The common name or ID for the |
| | marker. |
| Datum Type | This value may be always |
| | “STS_marker”. |
| Start | The start position of the marker on the |
| | chromosome. |
| End | The end position of the marker on the |
| | chromosome. |
| Orientation | The marker's orientation. One of the |
| | following: forward or reverse. |
| All_Names | All aliases associated with this marker. |
| STS-UID | An internal identifier for the marker. |
| | STS_UIDs can be system-generated |
| | and can be always unique. |
| STS_Name | The common name or ID for the |
| | marker. |
| STS_Fuzzy | The STS_Fuzzy value indicates |
| | whether the STS marker resides on a |
| | scaffold that may be “ordered” or |
| | “bounded.” |
| | If the scaffold may be “ordered,” it may |
| | be a seed scaffold used in mapping |
| | scaffolds to chromosomes, and its |
| | position may be not fuzzy; otherwise, |
| | the scaffold may be “bounded” and it |
| | may be not used as a seed scaffold to |
| | map scaffolds on chromosomes. One |
| | of the following appears: |
| | 1 - True. The marker resides on a |
| | scaffold that was not used as a seed |
| | scaffold to map scaffolds to |
| | chromosomes. |
| | 0 - False. The marker resides on a |
| | scaffold that was used as a seed |
| | scaffold to map scaffolds to |
| | chromosomes. |
| Axis_Begin | The start position of the marker on the |
| | chromosome. |
| Axis_End | The end position of the marker on the |
| | chromosome. |
| Entity_Length | The marker length. |
| Chrome | The chromosome number on which the |
| | marker resides. |

Table 4 below describes syntenic block properties. Some configurations may utilize a subset of the properties listed here. Properties need not be limited to those listed in this table. Some configurations may add additional properties not listed for implementation convenience and/or to expand the set of available features.

TABLE 4
Syntenic block properties and descriptions

| Property | Description |
|---|---|
| Datum Name | The Celera Syntenic Block accession |
| | number. |
| Datum Type | This value may be always |
| | “Syntenic_block”. |
| Start | The begin position of the syntenic block |
| | on the selected chromosome axis. |
| End | The end position of the block on the |
| | selected chromosome axis. |
| Orientation | The orientation of the syntenic block on |
| | the selected chromosome axis. One of |
| | the following values appears: forward |
| | or reverse. |
| ID | The Celera Syntenic Block accession |
| | number |
| Align_UID | An internal identifier for the syntenic |
| | block alignment sequence in the query |
| | genome for this feature. The |
| | Align_UID may be system-generated, |
| | and the number of digits may vary. It |
| | may be always unique. |
| Align_UID_Comp | An internal identifier for the syntenic |
| | block alignment sequence in the |
| | subject genome for this feature. The |
| | Align_UID_Comp may be system- |
| | generated, and the number of digits |
| | may vary. It may be always unique. |
| Organism | The syntenic block sequence source |
| | organism. For example, Mus |
| | musculus. |
| Organism_COMP | The comparative organism with |
| | genomic sequence similar to that of the |
| | source organism. For example, Homo |
| | sapiens. |
| Chromosome | The source organism's chromosome |
| | number on which the syntenic block |
| | falls. |
| Chromosome_COMP | The comparative organism's |
| | chromosome number on which the |
| | syntenic block falls. |
| Orientation | Either 1 (forward) or −1 (reverse) |
| Orientation_COMP | Either 1 (forward) or −1 (reverse) |
| Begin | The begin position of the syntenic block |
| | on the source organism's chromosome |
| End | The end position of the syntenic block |
| | on the source organism's chromosome |
| Begin_COMP | The begin position of the syntenic block |
| | on the comparative organism's |
| | chromosome |
| End_COMP | The end position of the syntenic block |
| | on the comparative organism's |
| | chromosome |
| SeqLength | The sequence length |
| SeqLength_COMP | The sequence length |
| AnchorNumber | The number of anchors in the block |

Table 5 below describes gene properties. Some configurations may utilize a subset of the properties listed here. Properties need not be limited to those listed in this table. Some configurations may add additional properties not listed for implementation convenience and/or to expand the set of available features.

TABLE 5
Gene properties and descriptions

| Property | Description |
|---|---|
| Datum Name | The Celera Gene (hCG or mCG) |
| | number, automatically assigned during |
| | annotation. |
| Datum Type | This value may be always “Gene”. |
| Start | The begin position of the gene on the |
| | chromosome |
| End | The end position of the gene on the |
| | chromosome |
| Orientation | The gene's orientation on the |
| | chromosome. One of the following |
| | appears: forward or reverse. |
| Genemap_UID | An internal identifier for the gene. |
| | Genemap_UIDs can be system- |
| | generated; they can be always unique. |
| Genemap_Name | The common gene name |
| Genemap_CG | The Celera Gene (hCG) number, |
| | automatically assigned during |
| | annotation |
| Genemap_Symbol | The gene symbol |
| Axis_Begin | The begin position of the gene on the |
| | chromosome |
| Axis_End | The end position of the gene on the |
| | chromosome |
| Genemap_CT_Number | The Celera Transcript (hCT or mCT) |
| | number(s) associated with the gene. |
| Genemap_Family | The Celera Discovery System (CDS) |
| | protein classification PANTHER ™ |
| | family name for the Celera protein |
| | (hCP or mCP) associated with this |
| | gene |
| Entity_Length | The length of the sequence in the entity |
| Genemap_Chrome | The chromosome number on which the |
| | gene resides |

Table 6 describes BAC Clone properties. Some configurations may utilize a subset of the properties listed here. Properties need not be limited to those listed in this table. Some configurations may add additional properties not listed for implementation convenience and/or to expand the set of available features.

TABLE 6
BAC Clone properties and descriptions

| Property | Description |
|---|---|
| Datum Name | The BAC ID |
| Datum Type | This value may be always “BAC”. |
| Start | The begin position of the BAC on the |
| | chromosome |
| End | The end position of the BAC on the |
| | chromosome |
| Orientation | The BAC'S orientation on the |
| | chromosome. One of the following |
| | appears: forward or reverse. |
| Bactile_UID | An internal identifier for the BAC. |
| | Bactile_UIDs can be system- |
| | generated; they can be always unique. |
| Bactile_Name | The BAC ID |
| Bactile_Fuzzy | The Bactile_Fuzzy value indicates |
| | whether the BAC resides on a scaffold |
| | that may be “ordered” or “bounded.” If |
| | the scaffold may be “ordered,” it may |
| | be a seed scaffold used in mapping |
| | scaffolds to chromosomes, and its |
| | position may be not fuzzy, otherwise, |
| | the scaffold may be “bounded” and it |
| | may be not used as a seed scaffold to |
| | map scaffolds on chromosomes. One |
| | of the following appears: |
| | 1 - True. The BAC resides on a |
| | scaffold that was not used as a seed |
| | scaffold to map scaffolds to |
| | chromosomes. |
| | 0 - False. The BAC resides on a |
| | scaffold that was used as a seed |
| | scaffold to map scaffolds to |
| | chromosomes. |
| Axis_Begin | The begin position of the BAC on the |
| | chromosome. |
| Axis_End | The end position of the BAC on the |
| | chromosome. |
| Length | The BAC length |
| Entity_Length | The BAC length |
| Bactile_Chrome | The chromosome number on which the |
| | BAC resides. |

Table 7 below describes cytoband properties. Some configurations may utilize a subset of the properties listed here. Properties need not be limited to those listed in this table. Some configurations may add additional properties not listed for implementation convenience and/or to expand the set of available features.

TABLE 7
Cytoband properties and descriptions

| Property | Description |
|---|---|
| Datum Name | The cytoband name |
| Datum Type | This value may be always “Cytoband”. |
| Start | The begin position of the cytoband on |
| | the chromosome |
| End | The end position of the cytoband on |
| | the chromosome |
| Orientation | The cytoband's orientation on the |
| | chromosome. One of the following |
| | appears: forward or reverse. |
| Bands_Name | The cytoband name |
| Axis_Begin | The begin position of the cytoband on |
| | the chromosome |
| Axis_End | The end position of the cytoband on |
| | the chromosome |
| Entity_Length | The cytoband length |
| Bands_Chrome | The chromosome number on which the |
| | cytoband resides |

Table 8 below describes scaffold properties. Some configurations may utilize a subset of the properties listed here. Properties need not be limited to those listed in this table. Some configurations may add additional properties not listed for implementation convenience and/or to expand the set of available features.

TABLE 8
Scaffold properties and descriptions

| Property | Description |
|---|---|
| Datum Name | The Genomic Assembly display name |
| | for the scaffold's nucleotide sequence |
| Datum Type | This value may be always “Scaffold” |
| Start | The begin position of the scaffold on |
| | the chromosome |
| End | The end position of the scaffold on the |
| | chromosome |
| Orientation | The scaffold's orientation on the |
| | chromosome. One of the following |
| | appears: forward or reverse. |
| Scaffoldmap_UID | An internal identifier for the scaffold. |
| | Scaffoldmap_UIDs can be system- |
| | generated; they can be always unique. |
| Scaffoldmap_Name | The Genomic Assembly display name |
| | for the scaffold's nucleotide sequence. |
| Axis_Begin | The begin position of the scaffold on |
| | the chromosome |
| Axis_End | The end position of the scaffold on the |
| | chromosome. |
| Entity_Length | The ungapped consensus length, or |
| | total number of nucleotides in the |
| | parent genomic assembly. |
| Scaffoldmap_Chrome | The chromosome number on which the |
| | scaffold resides |
| Scaffold_Previous | The Genomic Assembly display name |
| | for the previous scaffold in the genome |
| | assembly. |
| Scaffold_Next | The Genomic Assembly display name |
| | for the next scaffold in the genome |
| | assembly |

Configurations of the viewer may not be limited to displaying only the entities for which tables can be provided above. Additional property fields may exist for additional data entities that can be represented in the viewer in such configurations. For example, FIG. 26 shows some representative property tables that can be useful in some configurations of the viewer. The data shown for the various properties in the tables shown in FIG. 26 can be intended to be representative of actual data.

Identification of orthologs may be accomplished automatically in some configurations of the disclosed systems and methods. In some configurations, a pipeline method may be used (see FIG. 20) to identify orthologs cross species automatically. The pipeline can perform a mutual tblastx at step 180 between transcripts 182 and 184 from genomes of different species, such as the mouse and human genomes. The pipeline can select best putative ortholog matches at steps 188 and 200, and can find mutually best transcript pairs between the two species at step 186 selected from the best putative matches. The result is identification of ortholog data at step 202.

The pipeline method can include accessing pre-colloected ortholog data at step 204 to extract transcript data at step 206, extract mapping data at step 208, extract anchor data at step 210, and extract exon data at step 220. Syntenic bloc may be generated from the extracted mapping data, anchor data, and exon data at step 222. The generated syntenic block may be accessed at step 224 and combined with extracted transcript and identified ortholog data to perform a mini block match at step 226. Anchor pairing may be performed at step 228 based on the extracted mapping data, anchor data, and exon data. The resulting anchor ortholog may be accessed at step 230 and merged at step 232 with identified ortholog data and mini block ortholog accessed in step 234. The result is ortholog data update and/or supplementation at step 236.

The orthologs reported by the pipeline method can be mainly based on tblastx of mouse and human transcripts (for example). There can be several “evidence” fields that may be used to measure whether a given transcript pair may be truly orthologous to each other. The evidence fields may include:
a. <Expect>—the evalue of the tBlastx run between the transcripts;
b. <saNumber>—number of syntenic anchors shared by the two transcripts;
c. <saCoverage>—percent of exon length covered by the shared anchors; and
d. <block>—whether the two transcripts belong to the same syntenic block; if yes, information of the block may be presented.

A pair of transcripts may be likely to be truly orthologous to each other when they have significant tBlastx e-value and can be in the same syntenic block. Two orthologous genes can be most likely to share syntenic anchors; however, due to the mutually unique nature of syntenic anchors, anchors may be under represented in genome duplicated regions. The final output of the pipeline may be a XML file in some configurations of the pipeline.

In some configurations, three processes can be used in the pipeline: (I) data collection; (II) data computing; and (III) data integration. A centralized configuration file in XML format may be utilized for all three processes.

Data collection may be performed in various ways. In some configurations of the pipeline, to keep all input data in sync, the pipeline can take input files from a static view of the most current release of transcript annotation (also called a snap shot). While input (a) may be generated by content system, inputs (b), (c), and (d) can be generated by publishers embedded in the pipeline. The syntenic anchors files can be provided separately as flat files. A brief description of the input files follows.

(a) Fasta files can be blastable databases of transcripts that can be in the most current customer release.

A content system may run a publisher to make transcript fasta files for each customer release. (FASTA files can contain syntenic anchor sequences.) A database formatting program may be run on the fasta files. Files listed below can be updated whenever a new release may be published. (Other configurations may use different file names and/or locations.)

CHGD_transcripts.fasta (human)

CMGD_transcripts.fasta (mouse)

Links can be provided to enable one to determine the assembly version and release number of the transcripts.

(b) Transcript coordinate files—(which may, for example, be named query_transcripts.xml.gz and subject_transcripts.xml.gz) can be formatted in XML and contain the following information.
1. CT
2. CG
3. CP
4. scaffold_uid
5. scaffold_start
6. scaffold_end
7. orientation
8. chromosome
9. chromosome_start
10. chromosome_end
11. orientation

(c) Exon coordinate files (which may, for example, be named query_exons.txt.gz and subject_exons.txt.gz) ASCII format containing following information
1. CT_accession
2. exon uid
3. scffold ga uid
4. scaffold_start
5. scaffold_end
6. Orientation of exon
7. start coordinate on chr
8. end coordinate on chr

(d) Scaffold mapping files (which may, for example, be named query_map.xml.gz and subject_map.xml.gz). can be XML files that capture the following information:
1. scaffold_uid
2. chromosome
3. start on the chromosome
4. end on the chromosome
5. orientation

(e) Syntenic anchors (which may be named, for example, c4_mouse_anchors.gauid) may be a ASCII file containing the following columns with spaces as delimiters:
1. base genome ga uid
2. base genome scf start
3. base genome scf end
4. target genome ga uid
5. target genome sof start
6. target genome sof end

A data computing process is also described. The comparative data computing process may contains three different computing results: mutual tBlastx, computing anchor-based orthologs, and computing syntenic blocks.

A mutual tBlastx may be performed. Transcripts from one organism can be searched against transcripts from the other organism with the following parameters. The same search may be performed with the subject and query switched. Transcript pairs may be output if and only if they can be the top hit to each other (i.e., mutually best pairing). The parameters used in some configurations of the pipeline may be:
E value<10⁻⁴
Max Alignments=5
Max Definitions=5
Filter=false
Search Space=6×10⁹.

Anchor-based orthologs may be computed. In some configurations of the pipeline, pairs of human and mouse genes whose exons share anchors can be reported as potential orthologs. For each pair of transcripts, two values can be calculated to represent the degree of anchor sharing: (1) the number of anchors shared by the gene pair, and (2) the percentage of total exon length covered by the shared anchors. The input files can include exon coordinate files and an anchor file with scaffold coordinates. The output file can include mCT accession, hCT accession, number of shared anchor, and percent of exon length covered by shared anchors. Program modules may include a module to get anchor information from the anchor file; a module to get exon positions and length from the exon input file; and a module to match exons from two species (e.g., human and mouse) that share common anchors, and to compute the number of anchors shared and total shared length for each pair of transcripts.

Syntenic blocks may be computed. To compute syntenic blocks, a chromosome level grouping may be performed. To perform this grouping, anchors can be sorted by their chromosome position on the base chromosome. The anchors can then be grouped by their chromosome assignment on the target chromosome. In some configurations, those groups that have <2 anchors can be excluded. Next, within the chromosome grouping, the anchors can be sorted by their order on the base chromosome. The anchors can be grouped together if the order jump may be ≦2. Also in some configurations, groups that have ≦2 anchors or span (either human or mouse) ≦100,000 bp can be excluded.

Scripts can be used to automate these tasks. A syntenic anchor file in scaffold coordinates may be used as input. An output file may be produced that may be named all.syn.block in some configurations of the pipeline. This file may be formatted to include:
(1) base genome chromosome name;
(2) base genome chromosome start;
(3) base genome chromosome end;
(4) base genome span;
(5) target genome chromosome name;
(6) target genome chromsome start;
(7) target genome chromosome end;
(8) block orientation relative to base genome; and
(9) the number of anchors in the block.

Some configurations can utilize spaces as a delimiter in this file.

Data integration is further descxribed. At the end of the pipeline, the computing results of tBlastx, anchor-based orthologs, and syntenic blocks can be integrated to make a single output file. Further information concerning protein gene ontology (GO) and PANTHER™ classification may also be added in some configurations of the pipeline, when such information may be available. The output file may be based on gene pairs identified by mutually best tBlastx, i.e., gene pairs linked by syntenic anchors, but not by mutually best tBlastx, will be dropped. The opposite may also be true, i.e., two genes identified by mutually best tBlastx will be output, even if these genes do not share any syntenic anchors.

In some configurations, integration may comprise three processes:

(a) Query protein annotation database to get GO and PANTHER™ information for each transcript. Before the query, functional annotations can be completed and the protein annotation database may be updated so that it may be synchronized with the transcript customer release.

(b) Testing whether two transcripts in an orthologous pair belong to the same syntenic block. Provided that x may be a segment of chromosome of species A and y may be a segment of chromosome of species B; x, y can be synBlocks to each other and gene p of species A may be orthologous to gene q of species B. Ortholog(p,q) may be inside this synBlock if p may be contained in or overlaps with x and q may be contained in or overlaps with y. An ortholog(p,q) may be in a synBlock if it may be inside any synBlock between species A and B.

(c) Integrating. In some configurations of the pipeline, results generated from tBlastx, anchor-based orthologs and syntenic blocks, GO and PANTHER™ queries can be put into a single XML file. For orthologs for which two transcripts do not belong to the same syntenic block, the syntenic block <block> may be entirely dropped in some configurations; however, the <saNumber> and <sacoverage> can be still reported if there can be any shared syntenic anchors.

In some configurations of the pipeline, two tBlastX runs can be performed between human and mouse transcripts with subject and query databases swapped between runs. Next, mutually best transcript pairs can be selected as putative orthologs between the two species. The criterion for the best-hit selection may be the e-value of the top HSP between two transcripts. However, detection of the highest similarity does not necessarily result in the identification of the complete set of orthologs. If gene duplications occurred in each of the two compared species, the mutual best selection may only select one of the duplicated gene into the ortholog list. Thus, one or more of the methods described below can be provided in some configurations to identify orthologs in addition to the tBlastX mutual best selection.

(a) Identification of orthologs at evolutionary conserved locations by syntenic anchors. Syntenic anchors can be mutually unique locations that may be conserved between two genomes. The anchor density on exons may be 10 times higher than that of intergenic and intronic regions of the genome. Thus, in some configurations of the pipeline, a pair of human and mouse transcripts can be considered ortholog if they satisfy following conditions:
(i) They can share common anchor(s);
(ii) They can be in the same syntenic block;
(iii) They have significant sequence similarity, e.g., they can be the mutual top 5 tBlastX hit.

(b) Identification of orthologs at evolutionary conserved locations by divide-and-conquer method (mini block approach). In some configurations of the present pipeline, the mouse and human genomes can be divided into approximately 10000 evolutionally conserved segments (mini block). On average, there can be 3-5 transcripts in each mini-block. The human and mouse genes in the mini-block can be most likely evolutionary conserved and thus can be candidates for orthologs. A pair of transcripts may be identified as putative ortholog if they also share significant sequence similarity as judged by their presence in the top 5 mutual tBlastX hit. Thus, in some configurations of the ppipeline, the following algorithm may be performed:

(i) Identification of a “golden set” of orthologs: These orthologs can be the most confident ones and can be used as seeds to divide syntenic blocks into approximately 10000 mini blocks. It may be the subset of tBlastX mutual best pairs. They may share syntenic anchor and in the same syntenic blocks. In addition, human transcripts and mouse transcripts in the same syntenic block may have to be in consistent chromosomal order.

(ii) Divide syntenic block into mini-block: All syntenic blocks can be divided into mini-blocks. The small segment on mouse and human genome formed by two adjacent orthologs from the golden set may be defined as a mini-block. The segments on mouse and human genome can be evolutionary conserved.

(iii) Conquer: After the genome may be divided into ˜10000 comparable mini-blocks, resolution and accuracy may be effectively increased by 10⁴. On average, there can be 3-5 pairs of transcripts in each mini-block. If any transcript on mouse may have significant sequence similarity to a human transcript in the same mini-block, they can be identified as a putative ortholog.

(c) Identification of orthologs by PANTHER™ sub-family classification: Orthologs genes tend to share same biological functions. PANTHER™ protein classification information may be used to identify orthologs if other evidences also support. A pair of PANTHER™-ortholog may have to satisfy the following conditions:
(i) They may have to belong to same PANTHER™ sub-family;
(ii) They may have to share common syntenic anchor(s); and
(iii) They may have to be in the same syntenic block.

In some configurations, the above three methods (a), (b), and (c) can be applied independently after the tBlastX mutual best selection. The last step of the pipeline may be consolidation of orthologs from all four methods into a final ortholog list. Each pair may be assigned a matrix score according the four line of evidences.

It may thus be observed that comparative genomics offered by configurations of the pipeline provide scientists with data and investigative tools to accelerate research and discovery in the biomedical field. For example, having human-mouse orthologous pairs available can allow scientists to identify quickly and confidently mouse orthologous genes for human disease or genes correlated to drug response. These pairs can also provide data to create animal models for target identification, validation and candidate screening. Scientists can thus be better able to understand human disease-related gene functions through SNP discovery and mutagenesis or knockout studies of the corresponding mouse orthologs.

Syntenic anchors may help define syntenic relationships between the human and mouse genomes. They can also help identify and confirm human-mouse ortholog pairs. The syntenic anchors and syntenic blocks can provide landmarks for navigation between human and mouse genomes. In some configurations of the pipeline, human-mouse orthologs and syntenic anchors can be accessible in an integrated web-based discovery platform that provides access to a set of genomic and biological data, and a map pipeline can provide an environment for navigating syntenic regions and orthologs between the human and mouse genomes.

The description of the systems, methods, viewers, and pipelines is merely exemplary in nature and, thus, variations that do not depart from the gist of the disclosure are intended to be within the scope of thereof. Such variations are not to be regarded as a departure from the spirit and scope of the disclosure.

References

1. PANTHER™ Protein Classification for Inference of Biological Function. Celera User Bulletin. 500204 07 002.

2. Ashburner, M. (2000) Gene ontology: tool for the unification of biology. The Gene Ontology Consortium, Nature Genet. 25, 25 9.

3. O'Brien, S. J., et al. (1999) The promise of comparative genomics in mammals. Science 286, 458 482.

4. Zou, Y R, et al. (1998) Function of the chemokine receptor CXCR4 in haematopoiesis and in cerebellar development. Nature 393, 595 599.

5. http://www.informatics.jax.org/menus/homology_menu.shtml

6. http://www.ncbi.nlm.nih.gov/Homology/

7. Makalowski, W and Boguski, M. (1998) Evolutionary parameters of the transcribed mammalian genome: An analysis of 2820 orthologous rodent and human sequences, Proc. Natl. Acad Sci. 95, 9407 9412.

8. http://www.enscmbl.org/Mus Musculus/Download

9. Annotation of Regulatory Regions in the Celera Human Genome, Celera User Bulletin. 5003 04 07 003.

10.Expert Annotation for high confidence gene calling in the Celera Mouse and Human Genomes. Celera User Bulletin. 5001 04 07 001.

All references and all citations herein including but not limited to the ten listed above are hereby incorporated by reference in their entireties.

1. An interactive display system comprising:
a database of comparative genomic data from at least two species; and
a viewer adapted to integrate the comparative genomic data.

2. An interactive display system according to claim 1, further comprising an ortholog identifier adapted to identify orthologous genes of the two or more species.

3. An interactive display system according to claim 1, wherein the comparative genomic data comprises syntenic anchors and syntenic blocks from the two or more species.

4. An interactive display system according to claim 3, wherein the two species include mouse and human.

5. An interactive display system according to claim 4, further comprising comparative genomic data from at least three species.

6. An interactive display system according to claim 5 wherein the at least three species include rat.

7. An interactive display system according to claim 1, wherein the viewer comprises a map viewer which shows genomic sequence information of the two or more species with markers therein.

8. An interactive display system according to claim 1, wherein the viewer comprises a TA viewer which shows at least one contig and fragments used to generate the contig.

9. An interactive display system according to claim 1, wherein the viewer comprises an evidence viewer which provides annotation information associated with transcribed regions of the genomic data from the at least two species.

10. An interactive display system according to claim 1, wherein the viewer comprises a synteny viewer which shows syntenic relationships between the genomic sequence data of the at least two species.

11. An interactive display system according to claim 1, wherein the viewer comprises a multiple sequence alignment viewer which shows multiple sequence alignments of genomic sequences of the at least two species.

12. An interactive display system according to claim 1, wherein the viewer comprises a trace viewer which shows single nucleotides in genomic sequences of the at least two species.

13. An interactive display system according to claim 1, wherein said viewer comprises at least two viewer components selected from the group consisting of:
(a) a map viewer which shows genomic sequence information of the two or more species with markers therein;
(b) a TA viewer which shows at least one contig and fragments used to generate the contig;
(c) an evidence viewer which provides annotation information associated with transcribed regions of the genomic data from the at least two species;
(d) a synteny viewer which shows syntenic relationships between the genomic sequence data of the at least two species;
(e) a multiple sequence alignment viewer which shows multiple sequence alignments of genomic sequences of the at least two species; and
(f) a trace viewer which shows single nucleotides in genomic sequences of the at least two species.

14. An interactive display system according to claim 13, wherein said viewer is adapted to allow a user to select viewer components, thereby averting display to the user and viewer interaction with unselected viewer components .

15. An interactive display system according to claim 13, wherein said viewer comprises at least three viewer components selected from the group.

16. An interactive display system according to claim 13, wherein said viewer comprises at least four viewer components selected from the group.

17. An interactive display system according to claim 13, wherein said viewer comprises at least five viewer components selected from the group.

18. An interactive display system according to claim 13, wherein said viewer comprises at least six viewer components selected from the group.

19. An interactive display system according to claim 1, wherein said database of comparative genomic data comprises susbstantially complete genomic sequence of the two or more species.

20. An interactive display system according to claim 1, wherein the system is provided in a stand-alone format.

21. An interactive display system according to claim 1, wherein the system is provided in a web-based format.

22. A method for generating a database of genomic sequences of two or more species which identifies orthologous genomic regions between the two or more species, comprising:
performing at least one BLAST search using the genomic sequences of each of the two or more species against the genomic sequences of each of the other of the two or more species;
selecting best putative ortholog matches; and
identifying best ortholog matches among the best putative ortholog matches.

23. A method according to claim 22 further comprising identifying syntenic anchors and syntenic block to facilitate selecting the best putative ortholog matches.

24. A method for identifying orthologous genomic regions between two or more species, comprising:
performing at least one BLAST search using each of the two or more species against each of the other of the two or more species;
selecting best putative ortholog matches; and
identifying best ortholog matches among the best putative ortholog matches.

25. A method according to claim 24, further comprising identifying syntenic anchors and syntenic block to facilitate selecting the best putative ortholog matches.

26. A method for communicating orthologous genomic regions between at least two species to a user, comprising:
accessing comparative genomic data from at least two species; and
providing a viewer adapted to integrate the comparative genomic data and present it to the user.

27. A method according to claim 26, further comprising identifying orthologous genes of the two or more species.

28. A method according to claim 27, further comprising:
performing at least one BLAST search using genomic data from at least one of the two species against genomic data of each of the other at least two species;
selecting best putative ortholog matches; and
identifying best ortholog matches among the best putative ortholog matches.

29. A method according to claim 28, further comprising identifying syntenic anchors and syntenic block to facilitate selecting the best putative ortholog matches.

30. A method according to claim 26, further comprising providing a map viewer which shows genomic sequence information of the two or more species with markers therein.

31. A method according to claim 26, further comprising providing a TA viewer which shows at least one contig and fragments used to generate the contig.

32. A method according to claim 26, further comprising providing an evidence viewer which provides annotation information associated with transcribed regions of the genomic data from the at least two species.

33. A method according to claim 26, further comprising providing a synteny viewer which shows syntenic relationships between the genomic sequence data of the at least two species.

34. A method according to claim 26, further comprising providing a multiple sequence alignment viewer which shows multiple sequence alignments of genomic sequences of the at least two species.

35. A method according to claim 26, further comprising providing a trace viewer which shows single nucleotides in genomic sequences of the at least two species.


SEQUENCE LISTING (21 sequences)

SEQ ID NO: 1 - DNA, 59 bp, Homo sapiens
ccagcttcgcctcaccccattacagtctcaccacgccccgtcccctctccgttgagccc

SEQ ID NO: 2 - DNA, 58 bp, Homo sapiens
cagcttcgcctcaccccattacagtctcaccacgccccgtcccctctccgttgagccc

SEQ ID NO: 3 - DNA, 58 bp, Homo sapiens
cgcgccttcgcccgggtggggcgctgcgctgtcagcggccttgctgtgtgaggcagaa

SEQ ID NO: 4 - DNA, 58 bp, Homo sapiens
cctgcgggggcaggggcgggctggttccctggccagccattggcagagtccgcaggct

SEQ ID NO: 5 - DNA, 58 bp, Homo sapiens
agggctgtcaatcatgctggccggcgtggccccgcctccgccggcgcggccccgcctc

SEQ ID NO: 6 - protein, 20 aa, Homo sapiens
MELENIVANSLLLKARQEKD

SEQ ID NO: 7 - DNA, 59 bp, Homo sapiens
atggagctcgagaacatcgtggccaactcgctgctgctgaaagcgcgtcaagaaaagga

SEQ ID NO: 8 - protein, 20 aa, Homo sapiens
YSSLCDKQPIGRRLFRQFCD

SEQ ID NO: 9 - DNA, 59 bp, Homo sapiens
ttatagcagtctttgtgacaagcaaccgataggaagacgtctcttcaggcagttctgtg

SEQ ID NO: 10 - protein, 20 aa, Homo sapiens
MTSRDALAARVAGTGPRWLS

SEQ ID NO: 11 - DNA, 59 bp, Homo sapiens
atgacgtcacgggacgcactcgccgcgagggttgccgggacgggcccaagatggctgag

SEQ ID NO: 12 - protein, 20 aa, Homo sapiens
ALVPLLPAAQSPIHCLAAKW

SEQ ID NO: 13 - DNA, 59 bp, Homo sapiens
cgccttggttccgcttctgcctgccgcgcagagccccattcattgccttgctgctaagt

SEQ ID NO: 14 - protein, 20 aa, Homo sapiens
MTSRDALAARVAGTGPRWLS

SEQ ID NO: 15 - DNA, 59 bp, Homo sapiens; identical to SEQ ID NO: 11

SEQ ID NO: 16 - protein, 20 aa, Homo sapiens
ALVPLLPAAQSPIHCLAAKW

SEQ ID NO: 17 - DNA, 59 bp, Homo sapiens; identical to SEQ ID NO: 13

SEQ ID NO: 18 - DNA, 58 bp, Homo sapiens
gcccctacctcaccacgccccccgcatcgccacgcccccgccatcgccacgcctccct

SEQ ID NO: 19 - DNA, 58 bp, Homo sapiens
taccatgcagtcccgccccgtcccttcctcgtcccgcctcgccgcgacacttcacaca

SEQ ID NO: 20 - DNA, 58 bp, Homo sapiens; identical to SEQ ID NO: 2

SEQ ID NO: 21 - DNA, 58 bp, Homo sapiens; identical to SEQ ID NO: 3